(19) United States
(12) Patent Application Publication
(10) Pub. No.: US 2007/0293216 A1
(43) Pub. Date: Dec. 20, 2007

(54) Method and system for providing PLN service to inbound roamers in a VPMN using a standalone approach when no roaming relationship exists between HPMN and VPMN

(75) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(73) Assignee: Roamware Inc.

(21) Appl. No.: 11/802,576

(22) Filed: May 23, 2007

Related U.S. Application Data
(63) Continuation-in-part of application No. 10/778,861, filed on Feb. 13, 2004.
(63) Continuation-in-part of application No. 10/782,681, filed on Feb. 18, 2004.
(63) Continuation-in-part of application No. 11/288,421, filed on Nov. 29, 2005.
(63) Continuation-in-part of application No. 11/429,448, filed on May 8, 2006.
(60) Provisional application No. 60/802,507, filed on May 23, 2006.
(60) Provisional application No. 60/447,533, filed on Feb. 14, 2003.
(60) Provisional application No. 60/447,998, filed on Feb. 18, 2003.
(60) Provisional application No. 60/631,337, filed on Nov. 29, 2004.
(60) Provisional application No. 60/679,444, filed on May 9, 2005.

(51) Int. Cl. H04Q 7/20

(52) U.S. Cl. 455/433

(57) ABSTRACT

The present invention provides a method for facilitating mobile communication of a subscriber associated with a home network roaming in a visited network. The method includes receiving at a service node, a registration message by the subscriber to register with the visited network that has a No-Roaming Agreement (NRA) with the home network. The method further includes sending by the service node, an update message to a switching unit to update a trigger profile information at the switching unit so as to enable redirection of call control associated with the subscriber to the service node, wherein the switching unit is associated with the visited network. The method further includes facilitating completion of the subscriber's registration process in the visited network by the service node. Finally, the method includes authenticating the subscriber by the service node with the home network using one or more parameters of the subscriber's profile information.

### RELATED APPLICATIONS

This application claims the benefit of U.S. Provisional Patent Application Ser. No. 60/802,507 filed on May 23, 2006. This application is a continuation-in-part of U.S. patent application Ser. No. 10/778,861, filed on Feb. 13, 2004, which claims the benefit of U.S. Provisional Patent Application Ser. No. 60/447,533, filed on Feb. 14, 2003. This application is also a continuation-in-part of U.S. patent application Ser. No. 10/782,681, filed on Feb. 18, 2004, which claims the benefit of U.S. Provisional Patent Application Ser. No. 60/447,998, filed Feb. 18, 2003. This application is also a continuation-in-part of U.S. patent application Ser. No. 11/288,421, filed on Nov. 29, 2005, which claims the benefit of U.S. Provisional Patent Application Ser. No. 60/631,337, filed on Nov. 29, 2004. This application is also a continuation-in-part of U.S. patent application Ser. No. 11/429,448, filed on May 5, 2006, which claims the benefit of U.S. Provisional Patent Application Ser. No. 60/679,444, filed on May 9, 2005. Each of the aforementioned patent applications is incorporated by this reference herein in its entirety.

### FIELD OF THE INVENTION

The present invention generally relates to mobile communication of roaming subscribers. More specifically, the invention relates to facilitating the subscriber's mobile communication at local rates even when they are roaming in a visited network.

### BACKGROUND OF THE INVENTION

Mobile communication services to roaming subscribers are becoming increasingly popular with increasing number of roamers. Network operators across the world tend to earn maximum revenues from these roamers. The roaming subscribers who visit different countries or states add to the majority of this roaming revenue. Hence, many of these network operators offer international roaming or national roaming to inbound roamers visiting their coverage area. Moreover, these network operators also offer national or international roaming to their outbound roaming subscribers. Additionally, they provide various value added services (VAS) such as Prepaid Local Number (PLN), Missed Call Alert (MCA), and GPRS roaming services to entice these national or international roamers, in order to increase their overall revenue.

In order to provide these services, a home network (HPMN) operator possess a roaming agreement with a visited network (VPMN) operator so that the HPMN operator's outbound roamers are able to use these VAS in the VPMN. Similarly, the VPMN operator offers these services to only those inbound roaming subscribers whose HPMN operator has a roaming agreement with the VPMN operator.

An earlier solution (as taught by the inventor of the present invention) given in U.S. patent application Ser. No. 10/782,681, entitled “Providing multiple MSISDN numbers in a mobile device with a single IMSI”, filed on Feb. 18, 2003, describes a system and service that provides a local number to roaming subscribers of the HPMN operator in selected visited networks (i.e. VPMNs). These VPMN operators have a roaming agreement with the HPMN operator. This service allows the VPMN operator to offer its inbound roaming subscribers a Prepaid Local Number (i.e. PLN) without changing their home network's SIM card. However, the system does not provide the inbound roaming subscribers with the PLN in the non-partner visited networks, which do not have a roaming agreement with the home network operator. This prohibits the subscribers roaming in the non-partner networks from receiving or making calls on their HPMN Mobile Station International Subscriber Directory Number (MSISDN). Moreover, the inbound roaming subscribers, using their respective PLNs, are charged for their mobile communication activities at rates that are less than international roaming rates. However, these charges are still close to national roaming rates, and hence the facility is not entirely at local dialing rates.

In certain cases, big HPMN operators do not prefer to have a roaming agreement with a new and smaller VPMN operator. In other words, maintaining the roaming agreement with these smaller VPMN operators is not a priority for big HPMN operators. Moreover, these small VPMN operators cannot even afford resources of establishing and maintaining the roaming relationship with these big HPMN operators. In addition, in cases when these smaller VPMN operators wish to launch their services soon, they cannot afford to rely on the time consuming commercial agreement process with the big HPMN operators. Hence, such small VPMN operators are unable to cater to their inbound/outbound roaming subscribers for the VAS, particularly with limited number of partner networks to cater these services.

In one or more of the above mentioned solutions, the VPMN operators are able to provide the PLN service to their inbound roaming subscribers (i.e. of the HPMN) only when they possess a special roaming partnership agreement with the HPMN operator. In accordance with the foregoing, there is a need in the art of a system, method, and a computer product, which allows the VPMN operator to provide the PLN service in the VPMN to its inbound roaming subscribers of the HPMN even when the HPMN operator has a No Roaming Agreement (NRA) with the VPMN operator. In addition, there is a requirement to allow the inbound roaming subscriber to make and receive calls, as well as send and receive messages, while being charged at local rates instead of relatively high roaming rates.

### SUMMARY

The present invention is directed to provide a method for facilitating mobile communication of a subscriber, associated with a home network, and roaming in a visited network, where the home network and the visited network may either be in same country or different countries. The visited network has a No-Roaming Agreement (NRA) with the home network. The method includes receiving at a service node, coupled to the visited network, a registration message from the subscriber to register with the visited network. The method further includes sending by the service node, an update message to a switching unit associated with the visited network to update a trigger profile information at the switching unit so as to enable redirection of call control associated with the subscriber to the service node. The method further includes facilitating completion of the subscriber's registration process in the visited network by the service node. Finally, the method includes authenticating by the service node, the subscriber with his home network using one or more parameters of the subscriber's profile information, and thereafter providing a PLN service to the subscriber in the visited network.

Another aspect of the invention presents a system for facilitating mobile communication of a subscriber, associated with a home network, and roaming in a visited network, where the home network and the visited network may either be in same country or different countries. The visited network has a No-Roaming Agreement (NRA) with the home network. The system includes a service node coupled to the visited network that receives a registration message from the subscriber to register with the visited network. The service node further sends an update message to a switching unit to update a trigger profile information at the switching unit so as to enable redirection of call control associated with the subscriber to the service node. The service node further facilitates completion of the subscriber's registration process in the visited network. Finally, the service node authenticates the subscriber with his home network using one or more parameters of the subscriber's profile information, and thereafter provides a PLN service to the subscriber in the visited network.

Yet another aspect of the present invention provides a computer program product including a computer usable program code for facilitating mobile communication of a subscriber, associated with a home network, and roaming in a visited network by, receiving at a service node, a registration message from the subscriber to register with the visited network. The service node is coupled to the visited network. The visited network has a No-Roaming Agreement (NRA) with the home network. The home network and the visited network may either be in same country or different countries. Further, a computer usable program code sends from the service node, an update message to a switching unit to update a trigger profile information at the switching unit so as to enable redirection of call control associated with the subscriber to the service node. Further, a computer usable program code facilitates completion of the subscriber's registration process in the visited network by the service node. Finally, a computer usable program code authenticates the subscriber, by the service node, with his home network using one or more parameters of the subscriber's profile information. Thereafter, the service node provides a PLN service to the subscriber in the visited network.

### BRIEF DESCRIPTION OF DRAWINGS

In the drawings, the same or similar reference numbers identify similar elements or acts.

FIG. 1 represents a system for providing Prepaid Local Number (PLN) service to a subscriber of Home Public Mobile Network (HPMN) in a Visited Public Mobile Network (VPMN) with No Roaming Agreement (NRA) between the HPMN and the VPMN, in accordance with an embodiment of the present invention;

FIG. 2 represents a flowchart for providing the PLN service to the subscriber in the VPMN, in accordance with an embodiment of the present invention;

FIG. 3 is a flow diagram representing a registration process of the subscriber attempting to register with the VPMN, in accordance with an embodiment of the present invention;

FIGS. 4A and 4B represent a flow diagram for authenticating the subscriber with his home network by a PLN service node coupled to the VPMN, in accordance with a first embodiment of the present invention;

FIG. 5 is a flow diagram for authenticating the subscriber by the PLN service node with his home network via a sponsoring network, in accordance with a second embodiment of the present invention;

FIGS. 6A and 6B represent a flow diagram of forwarding a Mobile Terminated (MT) call received on the subscriber's HPMN MSISDN to the subscriber's PLN in the VPMN, in accordance with an embodiment of the present invention;

FIGS. 7A and 7B represent a flow diagram of sending a missed call alert to the subscriber's PLN and a calling party originating a call when the call is received on the subscriber's HPMN MSISDN, in accordance with an embodiment of the present invention;

FIG. 8 is a flow diagram of sending a special number (S#) by the PLN service node upon receiving MT call on the subscriber's PLN when the subscriber is not registered with the VPMN, in accordance with an embodiment of the present invention;

FIGS. 9A and 9B represent a flow diagram of sending a trigger profile by the PLN service node upon receiving MT call on the subscriber's PLN, where the VPMN charges the MT calls received on the subscriber's PLN, in accordance with a first embodiment of the present invention;

FIG. 10 is a flow diagram of sending the special number (S#) by the PLN service node upon receiving the MT call on the subscriber's PLN, where the VPMN charges the MT calls received on the subscriber's PLN, in accordance with a second embodiment of the present invention;

FIG. 11 represents a flow diagram of Mobile Originated (MO) call from the subscriber's handset using an ISUP-based trigger, in accordance with an embodiment of the present invention;

FIG. 12 represents a flow diagram of MO Short Message Service (SMS) from the subscriber's handset without Customized Applications for Mobile network Enhanced Logic (CAMEL) or Intelligent Network (IN) equivalent support by interfacing with a prepaid Service Control Point (SCP), in accordance with an embodiment of the present invention;

FIG. 13 represents a flow diagram of MO General Packet Radio Service (GPRS) activity from the subscriber's handset without CAMEL or IN equivalent support by interfacing with the SCP, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, method, and a computer program product, to facilitate mobile communication of a subscriber associated with a home network in a visited network when the home network has No Roaming Agreement (NRA) with the visited network. The system provides a Prepaid Local Number (PLN) service to the subscriber in the visited network that allocates the PLN to the subscriber of the home network, in order to enable local rates dialing in the visited network. The system further provides an authentication mechanism to authenticate the subscriber with his home network despite having NRA with the visited network. In one embodiment of the present invention, the visited network may use a sponsoring network of a visited network that has a roaming agreement with the home network to authenticate the subscriber. In another embodiment of the present invention, the visited network may utilize the SS7 or non-SS7 (e.g., SS7 SMS based or non-SS7 SMS based) inter-working relationship with the home network to verify the subscriber's identity. The system further allows the subscriber to receive calls on his Mobile Station International Subscriber Directory Number (MSISDN) of the home network, in addition to receiving calls on his PLN at local rates, while roaming in the visited network.

The system also allows the subscriber to request an activation of call forwarding service in the visited network. This service allows the subscriber to conditionally or unconditionally forward incoming calls on his home network's MSISDN to his PLN (i.e. allocated by the visited network). Alternatively, the subscriber can also opt to receive a Missed Call Alert (MCA) on his PLN, in order to avoid the call forwarding costs being levied by the home network operator. The system further facilitates the subscriber with an MT SMS services on his home network MSISDN, while he is roaming in the visited network. The subscriber may also wish to receive SMS, sent on his MSISDN, while he is roaming in visited network. This can be achieved by activating SMS forwarding service, which allows him to forward one or more SMS received on his MSISDN-H, to his PLN. In another embodiment of the present invention, the visited network can offer these VAS(s) (such as call forwarding, MCA, or SMS forwarding) in a welcome SMS. However, this welcome message may be sent to the subscriber's PLN, once he successfully registers and gets verified by his home network. This service requires home network to support SMS forwarding capability across different operators. Alternatively, if no such support exists, the subscriber at that particular instance will not receive the MT SMS, sent on his MSISDN-H. However, he can still receive the SMS later when he registers back with the home network as SMS delivery is performed using store and forward technique, where this SMS is stored in an SMSC of the subscriber's home network that delivers the SMS when the subscriber registers back with the home network. Additionally, configuration settings at various components in the visited network are used to enable redirection of the subscriber's call control to a service node being deployed in the visited network. The service node upon receiving the call control, allows the subscriber to perform various call and non-call related activities in the visited network.

The present system caters to both postpaid and prepaid subscribers of the home network, while they are roaming in the visited network, which is either in same country or different country as the home network. Moreover, the PLN service offered by the visited network operator complies with a BA 30 guideline, in accordance with various embodiments of the present invention. This guideline ensures that the subscriber of the home network operator registers with the visited network only when the following criteria are met: the subscriber manually selects the visited network, the subscriber consents to the PLN service in the visited network, or there is no other network operator's coverage other than the visited network's coverage. The system further provides a charging mechanism that charges the subscriber's mobile activities in the visited network, such as calls on and from the PLN, at local rates. The system further provides the subscriber with an option whether he wants to avail the PLN facility on a temporary basis, or for a longer duration.

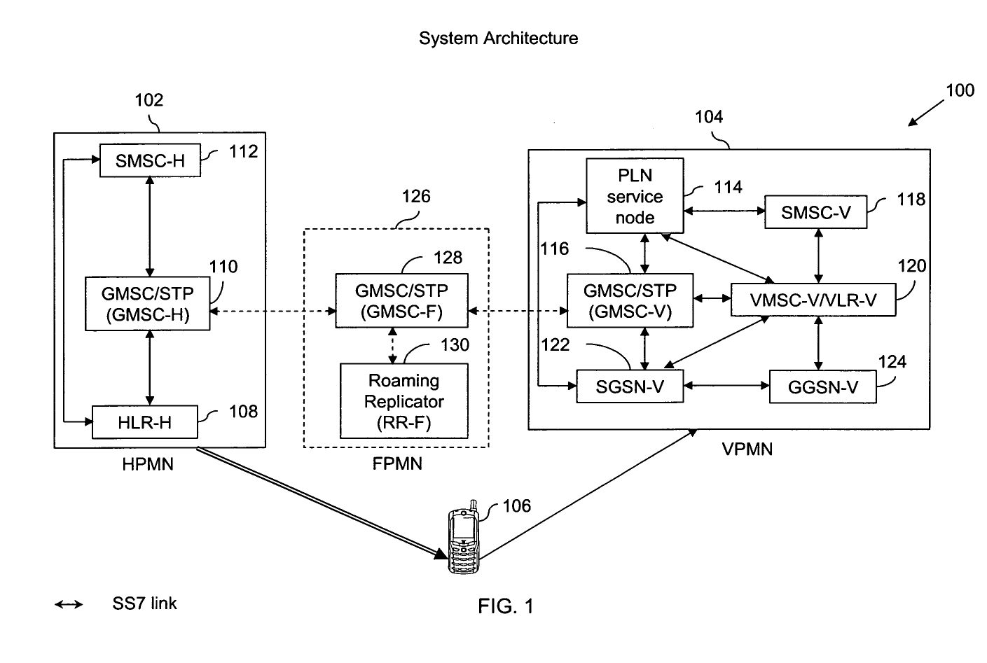

FIG. 1 represents a system 100 for providing the PLN service to the subscribers of a Home Public Mobile Network (HPMN) 102 in a Visited Public Mobile Network (VPMN) 104, with No Roaming Agreement (NRA) between HPMN 102 and VPMN 104. In one embodiment of the present invention, HPMN 102 and VPMN 104 are located in the same country. In another embodiment of the present invention, HPMN 102 and VPMN 104 are located in different countries. A subscriber 106, who is originally associated with HPMN 102, attempts to register with VPMN 104. Since there is NRA between HPMN 102 and VPMN 104, VPMN 104 provides the PLN service to subscriber 106, by using an inter-working relationship with HPMN 102 to exchange signaling with HPMN 102. Thus, in one embodiment of the present invention, HPMN 102 and VPMN 104 exchange signaling via a Signaling System 7 (SS7) inter-working relationship. In another embodiment of the present invention, HPMN 102 and VPMN 104 exchange signaling using a non-SS7 inter-working via an indirect relationship. The indirect relationship can be an intermediate operator between HPMN 102 and VPMN 104. Moreover, when there exists an SS7 based SMS inter-working or non-SS7 based SMS inter-working between HPMN 102 and VPMN 104, they may also exchange SMSs (e.g., MAP RegisterSS), in accordance with an embodiment of the present invention. HPMN 102 includes a Home Location Register (HLR) 108, a Gateway Mobile Switching Center/Signal Transfer Point (GMSC/STP) 110, and a Short Message Service Center (SMSC) 112. Since HLR 108, GMSC/STP 110, and SMSC 112 reside in HPMN 102, they are hereinafter referred to as HLR-H 108, GMSC-H 110, and SMSC-H 112, respectively. HLR-H 108, GMSC-H 110, and SMSC-H 112 are interconnected, and communicate with each other over an SS7 link. HLR-H 108 is interchangeably, referred to as home location information database, in accordance with another embodiment of the present invention.

System 100 further includes in VPMN 104 a PLN service node 114. PLN service node 114 intercepts all incoming and outgoing signaling messages from VPMN 104. In addition, VPMN 104 uses PLN service node 114 to provide the PLN service to subscriber 106. Hence, PLN service node 114 acts as an HLR to the pool of pre-defined local numbers (i.e. PLNs and special PLNs) provisioned by VPMN 104. Various other functionalities of PLN service node 114 are described later in context of the present invention. PLN service node 114 is interchangeably referred to as service node 114, in accordance with various embodiments of the present invention. VPMN 104 further includes a Gateway Mobile Switching Center/Signal Transfer Point (GMSC/STP) 116, a Short Message Service Center (SMSC) 118, and a Visited Mobile Switching Center/Visited Location Register (VMSC/VLR) 120. Since GMSC/STP 116, SMSC 118, and VMSC/VLR 120 reside in VPMN 104, they are hereinafter referred to as GMSC-V 116, SMSC-V 118, and VMSC-V/VLR-V 120, respectively. GMSC-V 116, SMSC-V 118, and VMSC-V/VLR-V 120 are interconnected and communicate with each other over an SS7 link. GMSC-V 116 is interchangeably, referred to as a gateway switching center, in accordance with an embodiment of the present invention. In addition, VMSC-V/VLR-V 120 is interchangeably referred to as a switching unit, in accordance with an embodiment of the present invention. System 100 further includes in VPMN 104, a Serving GPRS Support Node (SGSN) 122 and a Gateway GPRS Support Node (GGSN) 124. Since SGSN 122 and GGSN 124 reside in VPMN 104, they are hereinafter referred to as SGSN-V 122 and GGSN-V 124.

In an embodiment of the present invention, as there is NRA between HPMN 102 and VPMN 104, VPMN 104 uses PLN service node 114 to authenticate subscriber 106 with HPMN 102, using the SS7 or the non-SS7 based SMS inter-working relationship between HPMN 102 and VPMN 104. Alternatively, in accordance with another embodiment of the present invention, PLN service node 114 uses a sponsoring network 126 of VPMN 104 to exchange signaling with HPMN 102, and thereby authenticating subscriber 106 with HPMN 102. Sponsoring network 126 has a roaming agreement with both HPMN 102 and VPMN 104. Thus, sponsoring network 126 is hereinafter referred to as Friendly Public Mobile Network (FPMN) 126. FPMN 126 is an optional system element, which is used only in case VPMN 104 wants to authenticate subscriber 106 via the sponsoring network, and is hence represented by dotted lines in FIG. 1. FPMN 126 includes a Gateway Mobile Switching Center/Signal Transfer Point (GMSC/STP) 128 and a Roaming Replicator (RR) 130. RR 130 is an enhanced signaling gateway that facilitates exchange of signaling messages, such as voice messages and data packets (also PDP packets for GPRS), between HPMN 102 and VPMN 104. As GMSC/STP 128 and RR 130 reside in FPMN 126, they are hereinafter referred to as GMSC-F 128 and RR-F 130, respectively. RR-F 130 is interchangeably referred to as a roaming gateway, in accordance with an embodiment of the present invention. Moreover, FPMN 126 may reside in the same country as VPMN 104, or may reside in a country where HPMN 102 is located. It will be apparent to a person skilled in the art that HPMN 102, VPMN 104, and FPMN 126 may also include various other network components (not shown in FIG. 1), depending on the architecture under consideration. It will be apparent to a person skilled in the art that HPMN 102, VPMN 104, and FPMN 108 may communicate using their international STPs if they are in different countries, or else may use their national STPs if they are in same country.

As mentioned above, VPMN 104 allocates the pool of pre-defined local numbers of VPMN 104 with their corresponding International Mobile Subscriber Identity (IMSIs) to PLN service node 114. Subscriber 106 can either send a request (i.e. via an SMS or an USSD request) to VPMN 104, or can manually select VPMN 104 in his registration attempt, in order to receive the PLN service in VPMN 104. Upon receiving the subscriber's registration attempt, PLN service node 114 retrieves a PLN or a special PLN (S#) from the pool of pre-defined local numbers, and sends it to VMSC-V/VLR-V 120.

In an embodiment of the present invention, subscriber 106 attempts to register with VPMN 104 when there is no network coverage, from any roaming partner network operator of HPMN 102, in proximity to VPMN 104. This is essentially done to ensure that VPMN 104 conforms to BA 30 guideline, before it allows subscriber 106 to register at VPMN 104. The BA 30 guideline states that:

Quote:

“With regard to Roaming Subscribers belonging to an HPMN Operator with whom an Operator does not have an Agreement, such Operators are also prohibited from applying any technical network-based method contravening 3GPP standards which would interfere with the selection of other VPMN(s) with whom an HPMN Operator does have an Agreement, should such other VPMN(s) be available.”

Unquote

This means that in case there exists other VPMN(s) that possess roaming agreement with HPMN 102, then VPMN 104, which has NRA with HPMN 102, shall not provide any services like PLN service to these subscribers. Henceforth, such HPMN(s) are interchangeably referred to as NRA HPMN(s). However, BA 30 guideline does not restrict VPMN 104 to provide the PLN service to these subscribers, if there is no other network operator's coverage in proximity to VPMN 104. Moreover, the guideline does not restrict VPMN 104 to offer the PLN service to these subscribers, when they have consented to such a service. In an embodiment of the present invention, when subscriber 106 attempts to register with VPMN 104, VPMN 104 sends a confirmation request message to subscriber 106, requesting him to opt for the PLN service. Only when subscriber 106 has confirmed for this service is he allowed to register with VPMN 104.

Furthermore, in order to endorse the BA 30 guideline, VPMN 104 maintains a list of one or more networks operators, who possess a roaming agreement with HPMN 102. In an embodiment of the present embodiment, these network operators may be servicing in different countries. Hence, VPMN 104 offers the PLN service to subscribers of HPMN 102 only when the list is empty. In another embodiment of the present embodiment, VPMN 104 also maintains a list of one or more networks from different zones (within the same country as VPMN 104), that possess a roaming agreement with HPMN 102. Hence, VPMN 104 offers the PLN service to the subscribers of HPMN 102 in their respective zones in the VPMN 104's country, only when the zone list is empty.

In an embodiment of the present invention, subscriber 106 may attempt to register with VPMN 104 that is present in the forbidden list of the subscriber's SIM card. However, this happens usually when subscriber 106 has manually selected VPMN 104. For instance, when VPMN 104 and HPMN 102 are national competitive operators without national roaming agreement (i.e. national NRA), then all NRA HPMN subscribers would have VPMN 104 already forbidden in their respective SIM cards.

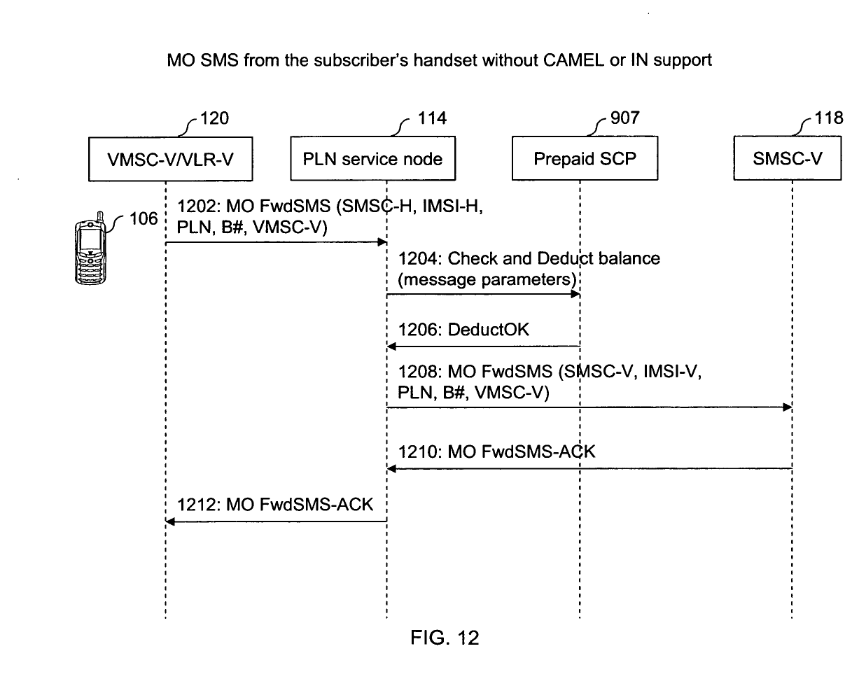

In addition, in order to provide the PLN service to subscriber 106 in VPMN 104, which has NRA with HPMN 102, an operator of VPMN 104 does a configuration at various components residing in VPMN 104. In an embodiment of the present invention, VPMN 104 assigns E.164 Global Title (GT) and Signal Point Code (SPC) to PLN service node 114. PLN service node 114 uses these GT and SPC to replace a Calling Party Address (CgPA) in all signaling messages intended for HPMN 102 with its own GT and SPC. The modification of the CgPA with the GT of PLN service node 114, allows receipt of response to all signaling messages with modified CgPA, at PLN service node 114. Further, PLN service node 114, which acts as an HLR for the PLN and the special PLN (i.e. S#), facilitates completion of registration and authentication process for subscriber 106 at VPMN 104. Various embodiments of sending MO Short Message Service (SMS) from the subscriber's handset to PLN service node, instead of SMSC-H, are described later in conjunction with FIG. 12.

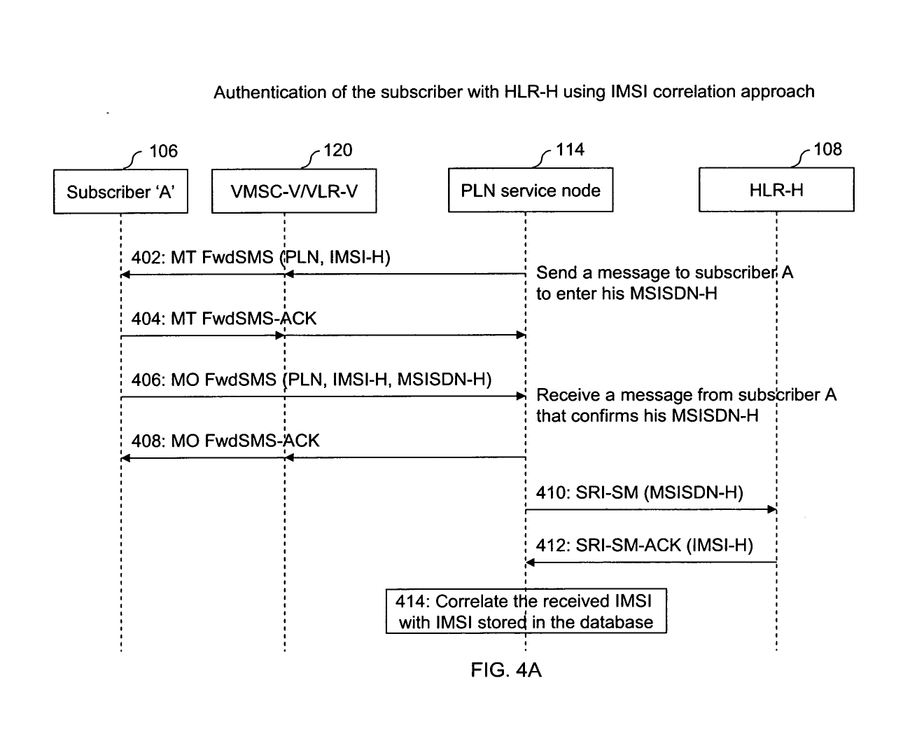

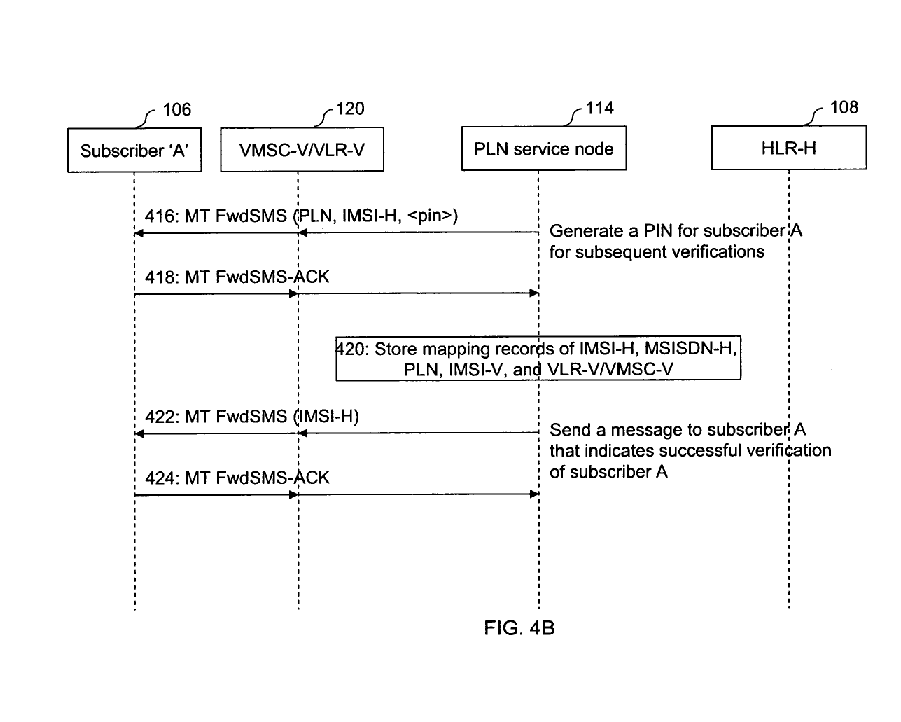

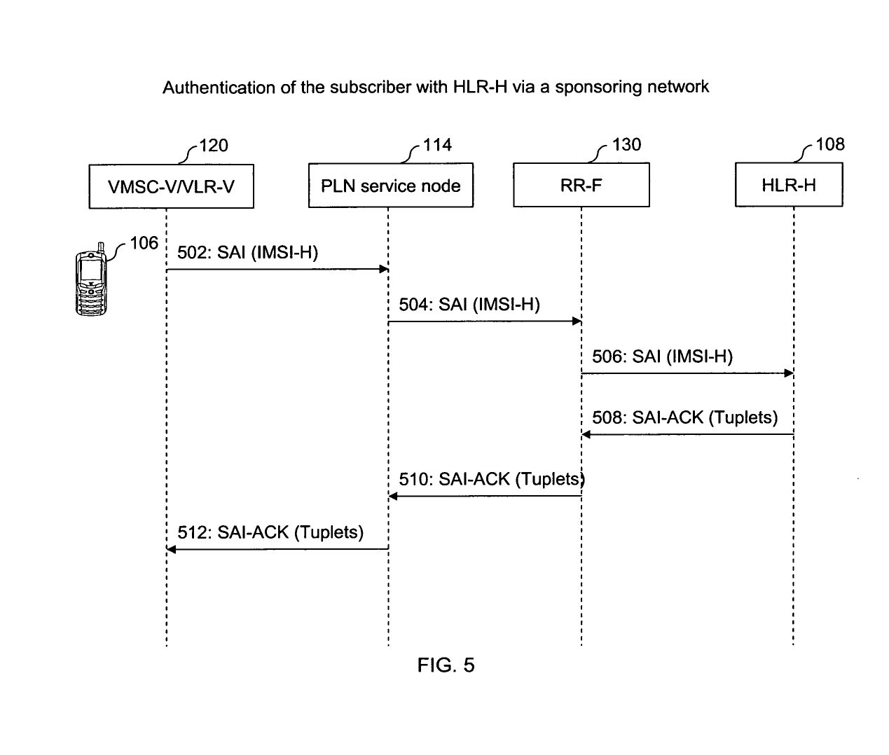

Once subscriber 106 has successfully registered with VPMN 104, PLN service node 114 sends a message to the subscriber 106's handset requesting him to verify his identity as a valid/legitimate subscriber of HPMN 102. Thus, in order to allow subscriber 106 to use the PLN service, an authentication procedure (or mechanism) is set forth in context of the present invention. In an embodiment of the present invention, PLN service node 114 can be used to authenticate subscriber 106 with his HPMN 102, using one or more parameters of the subscriber's profile information. These one or more parameters correspond to an IMSI of the subscriber's HPMN and a Personal Identification Number (PIN) (i.e. provided by VPMN 104 for the subscriber's verification). In another embodiment of the present invention, PLN service node 114 can retrieve one or more authenticating parameters, in order to authenticate subscriber 106 with HPMN 102. These one or more authenticating parameters correspond to triplets and quintuplets. These parameters may also consist of the IMSI of the subscriber's HPMN, depending upon the requirement of VPMN 104 operator. Additionally, the authenticating parameters can be stored in a database, associated with PLN service node 114, for subsequent verification of subscriber 106. Various embodiments for authenticating the subscriber with his home network are described in conjunction with FIGS. 4A and 4B, and FIG. 5.

Once VPMN 104 has successfully authenticated subscriber 106 with his HPMN 102, PLN service node 114 stores a mapping record of the IMSI of the subscriber's home network, an MSISDN of the subscriber's home network, a PLN of the subscriber's visited network, and an IMSI of the subscriber's visited network, in its database. Since the IMSI of the subscriber's home network and the MSISDN of the subscriber's home network are associated with HPMN 102, they are hereinafter referred to as IMSI-H and MSISDN-H, respectively. Further, the subscriber's IMSI in the visited network is hereinafter referred to as IMSI-V. Also, subscriber 106 is interchangeably referred to as subscriber A, in accordance with various embodiments of the present invention.

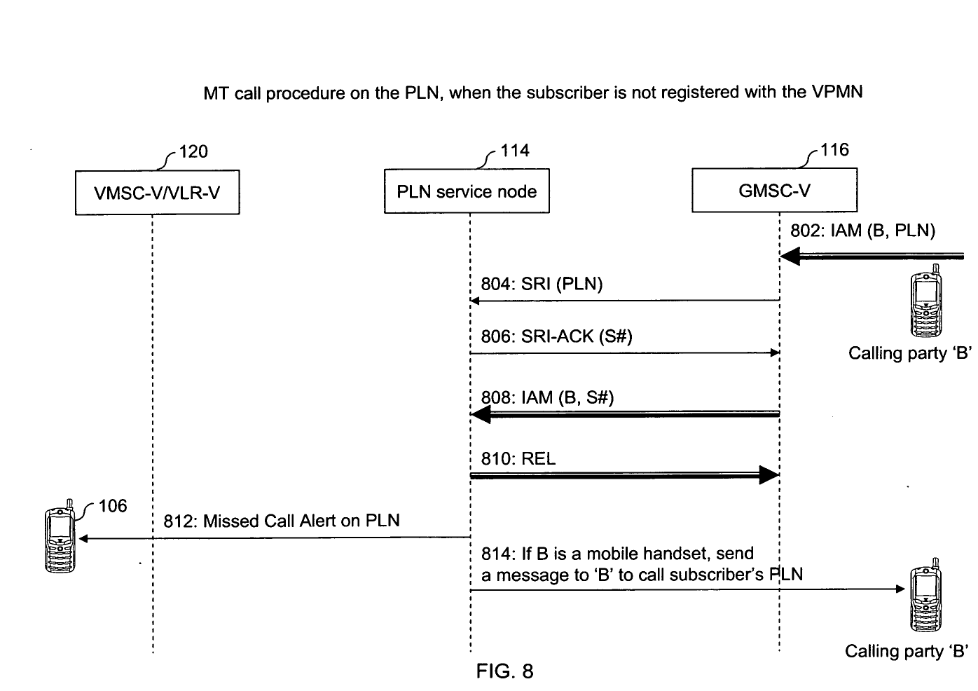

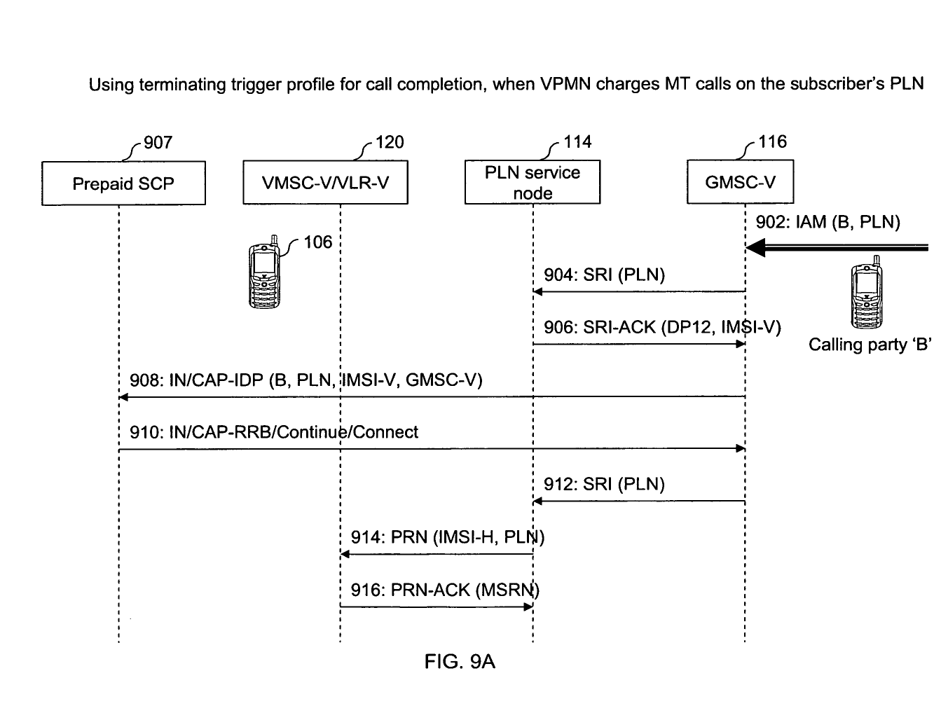

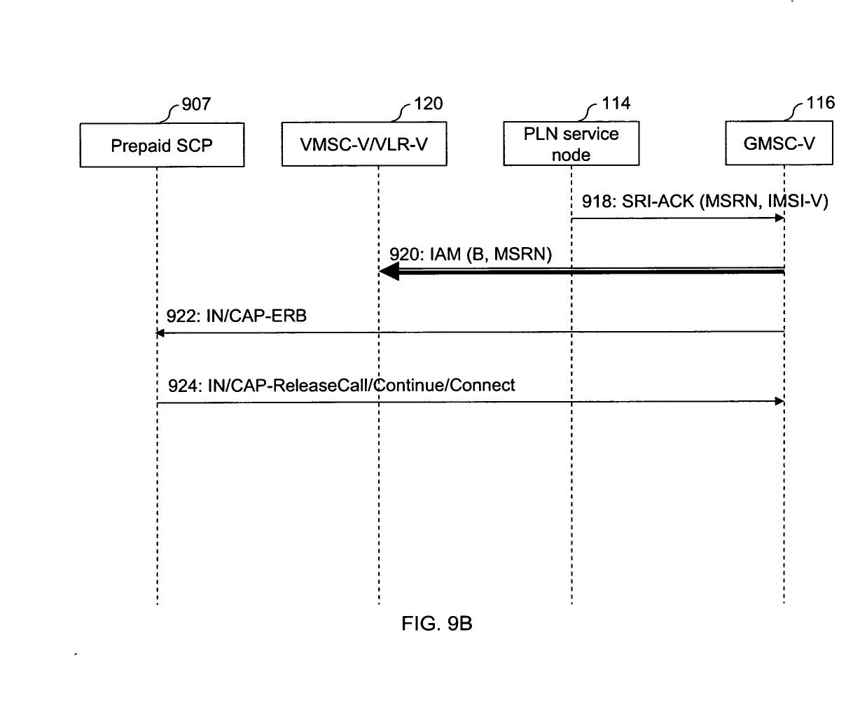

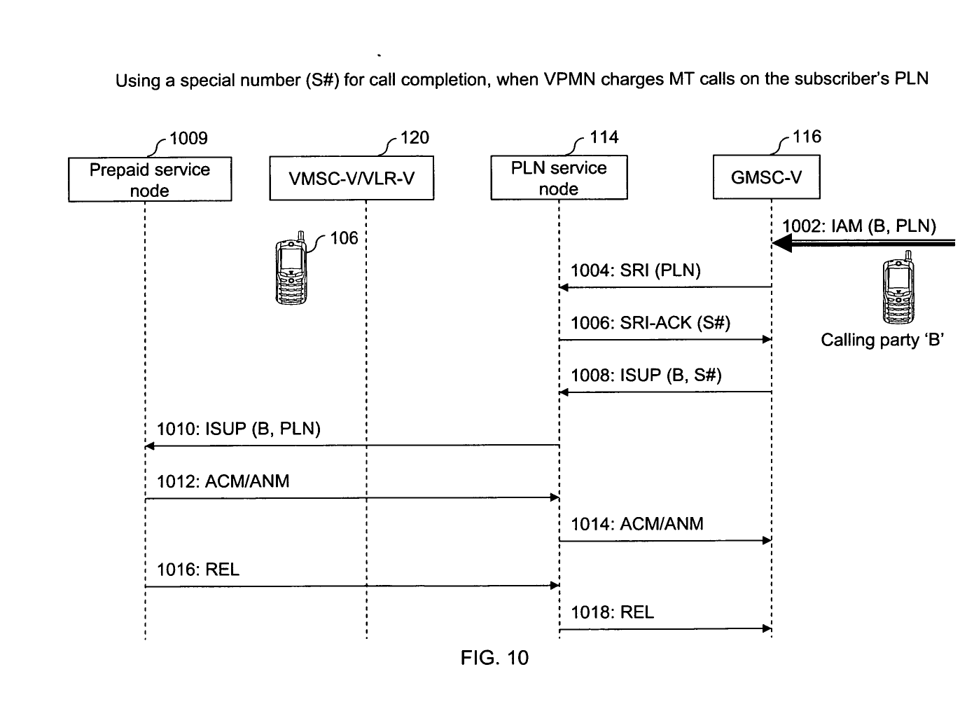

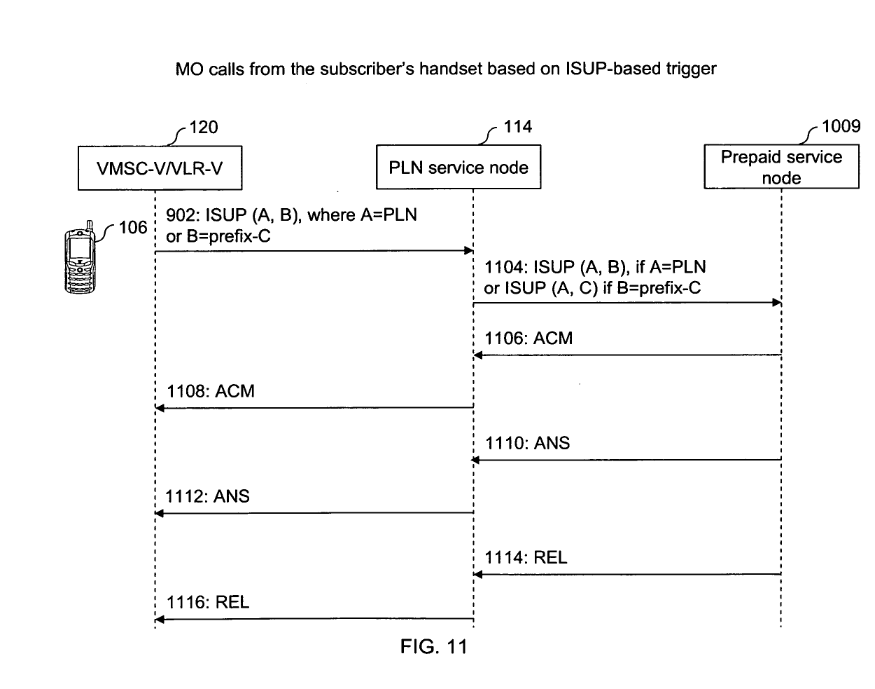

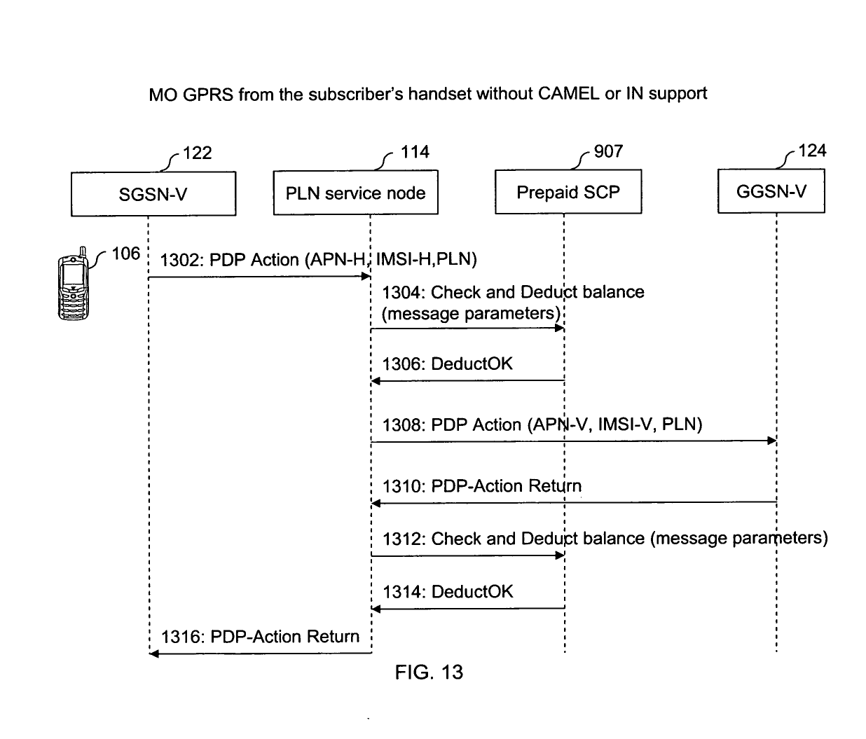

Once VPMN 104 provides the PLN to subscriber 106, he can initiate and receive calls and SMS, and perform other mobile activities, on his PLN. In accordance with another embodiment of the present invention, PLN service node 114 updates a prepaid service control node, residing in VPMN 104 with the PLN and the IMSI-V, to maintain billing records for the subscriber's mobile activities (i.e. using the PLN), in VPMN 104. Prepaid service control node can be either a prepaid SCP or a prepaid service node. As subscriber 106 can originate calls using his PLN, the calls from his PLN can be charged either by the prepaid service node or by the prepaid SCP, based on whether the calls from the subscriber's PLN are ISUP based MO calls, or IN/CAP based MO calls (i.e. in case subscriber 106 is a CAMEL subscriber of HPMN 102), respectively. Various embodiments for MO calls from the subscriber's PLN are described in conjunction with FIG. 11. Also, in case of an ISUP call, PLN service node 114 can forward the call to the prepaid service node, which acts as a prepaid interface handling all billing records. In an embodiment of the present invention, the operator of VPMN 104 may opt to charge MT calls on the PLN. In another embodiment of the present invention, these operators may like to offer free MT calls on the PLN. Various embodiments of MT calls on the subscriber's PLN are described in conjunction with FIG. 8, FIGS. 9A and 9B, and FIG. 10. Likewise, subscriber 106 may also like to subscribe to GPRS services, when he is roaming in VPMN 104. Thus, if VPMN 104 allows subscriber 106 to inbound roam, with GPRS services enabled, subscriber 106 uses an Access Point Name (APN) of HPMN 102 to initiate MO GPRS activities in VPMN 104, in order to access these GPRS services. Various embodiments for initiating MO GPRS activities from the subscriber's handset in the visited network are described in conjunction with FIG. 13.

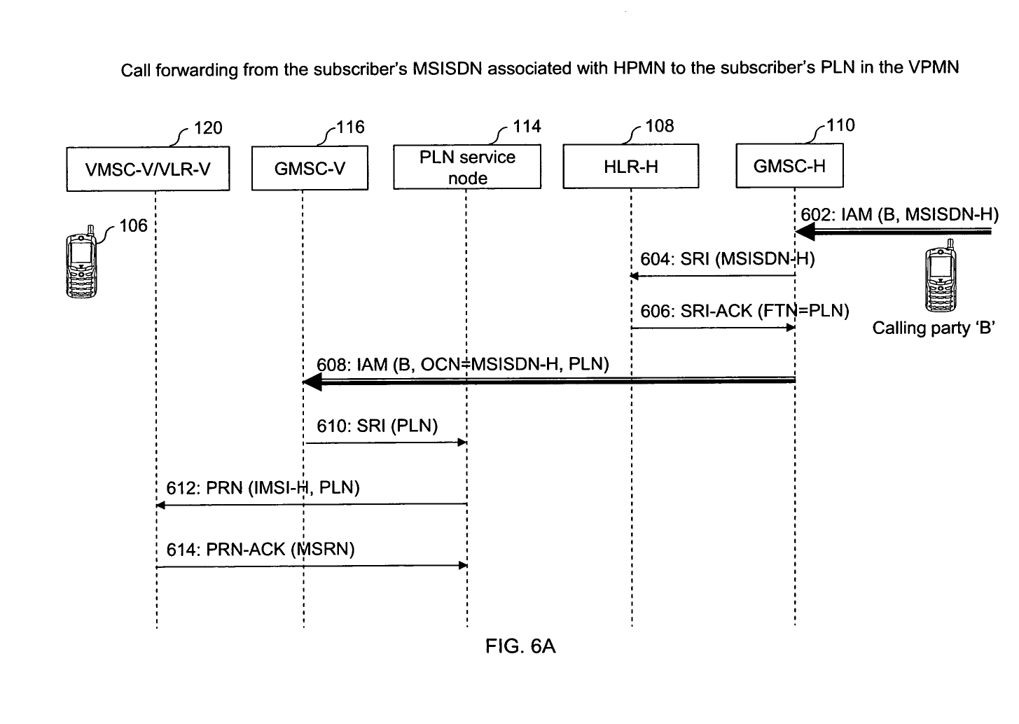

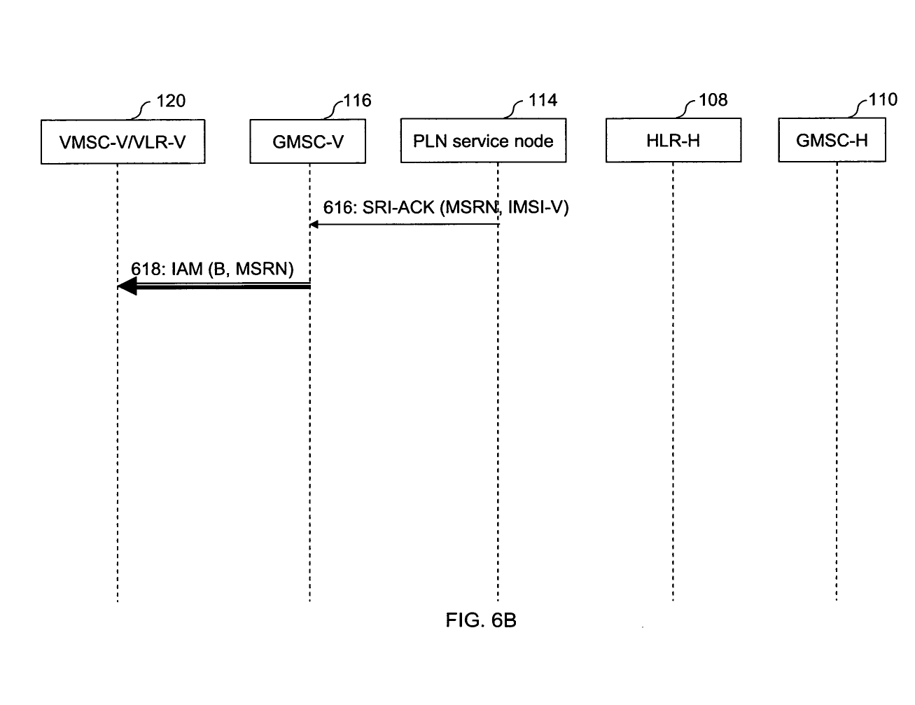

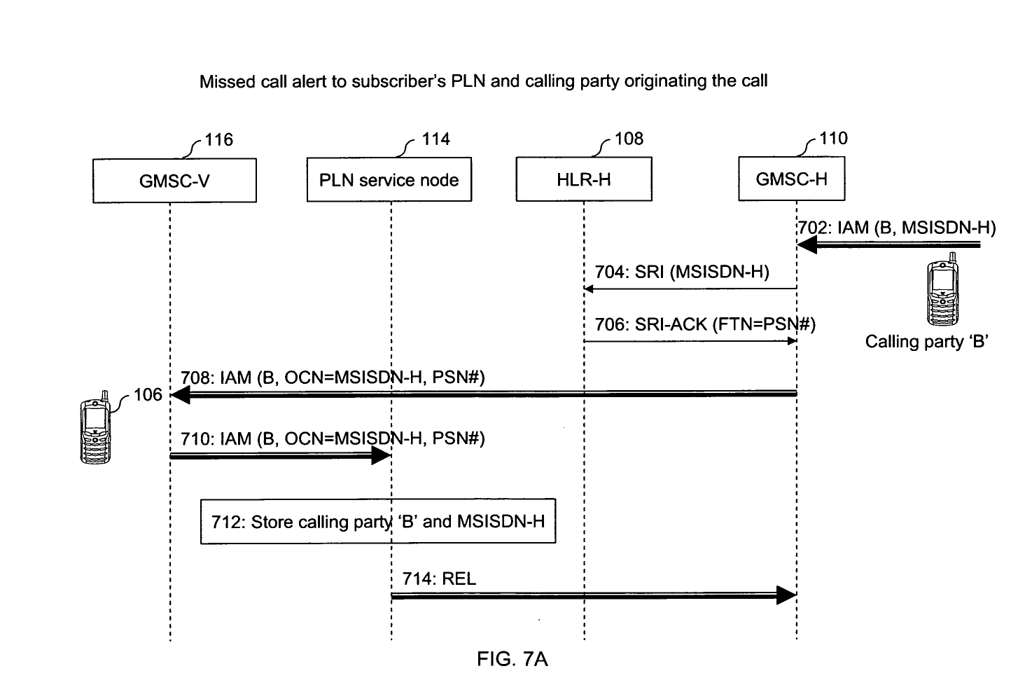

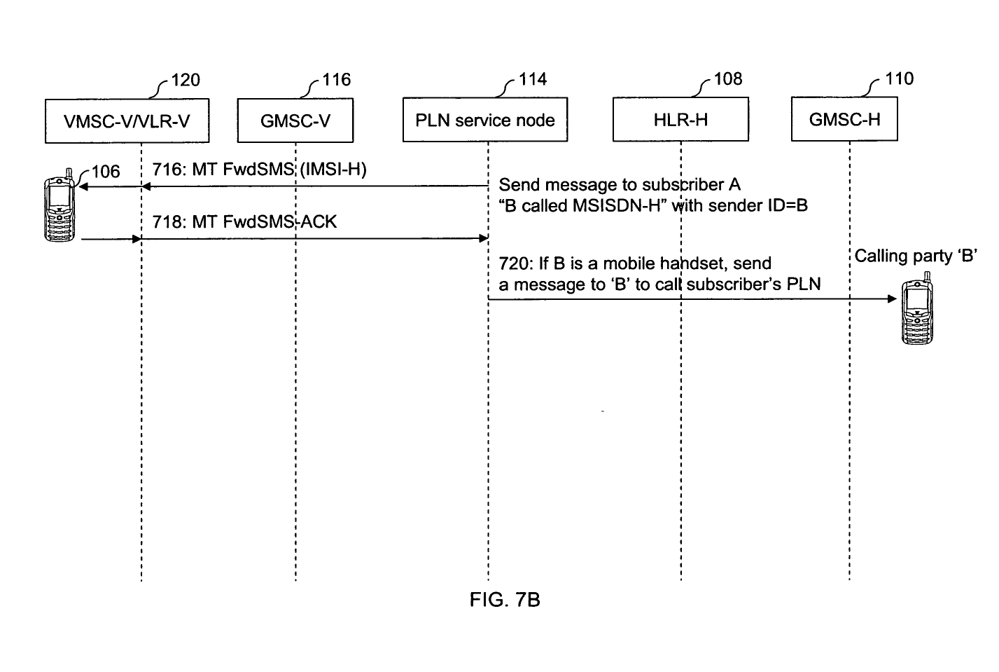

In another embodiment of the present invention, VPMN 104 allows subscriber 106 to receive calls on his MSISDN-H. This can be achieved by forwarding calls on his MSISDN-H to his PLN. Subscriber 106 may request conditional or unconditional call forwarding via customer care or Man Machine Interface (MMI), while he is registered with HPMN 102. In another embodiment of the present invention, if there exists SS7 inter-working between HPMN 102 and VPMN 104, subscriber 106 can still opt to forward MT calls on his MSISDN-H to his PLN, while he is registered with VPMN 104. Various embodiments of forwarding calls on the subscriber's MSISDN of the HPMN to the subscriber's PLN are described in conjunction with FIGS. 6A and 6B. Alternatively, subscriber 106 may opt to receive the MCA on his PLN number, upon receiving calls on his MSISDN-H. Moreover, PLN service node 114 may also send an MCA to a calling party originating the call. Various embodiments of redirecting MT calls on the special PLN to the PLN service node, and sending the MCA to the PLN and the calling party originating the call are described in conjunction with FIGS. 7A and 7B. Subscriber 106 may also receive SMS on his MSISDN-H. Various embodiments for the MT SMS on the subscriber's MSISDN-H are described later, in context of the present invention.

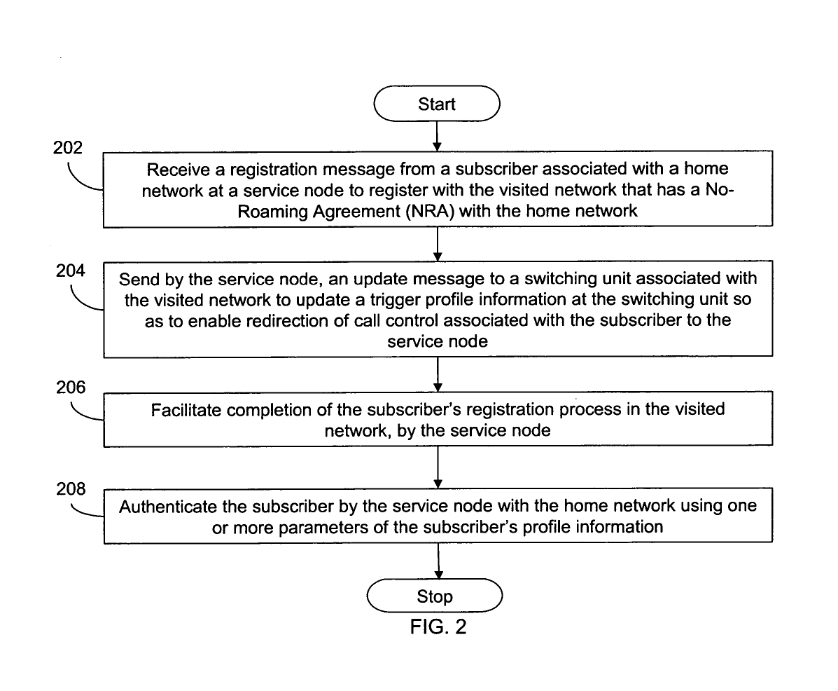

As described and mentioned above, in order to provide PLN service to the inbound roaming subscribers, VPMN 104 needs to verify these subscribers and allow them to register at their network. FIG. 2 represents a flowchart for providing PLN service to the subscriber in the VPMN, in accordance with an embodiment of the present invention. VMSC-V/VLR-V 120 detects the registration attempt from subscriber 106 to register at VPMN 104. At step 202, a service node (coupled to the visited network) receives a registration message from a subscriber (associated with a home network) to register with the visited network that has a NRA with the home network. In an embodiment of the present invention, when subscriber 106 makes a registration attempt at VPMN 104, VMSC-V/VLR-V 120 receives an LUP message from the subscriber's handset to register with VPMN 104. In an embodiment of the present invention, operator of VPMN 104 configures GMSC-V 116 to redirect all MAP signaling messages associated with subscriber 106's PLN, that are destined for HPMN 102, to PLN service node 114. This means that all signaling messages, such as Signaling Connection and Control Part (SCCP) messages, with E.214 Called Party Address (CdPA) as HPMN 102, are to be redirected to PLN service node 114. Hence, VMSC-V/VLR-V 120 forwards this LUP message to GMSC-V 116, which redirects the received LUP message to PLN service node 114. It will be apparent to a person skilled in the art that in case of GPRS location update, subscriber 106 sends a GPRS location update message, such as GPRS-LUP message, to SGSN-V 122 instead of VMSC-V/VLR-V 120.

Thereafter, at step 204, the service node sends an update message to a switching unit, associated with the visited network, to update a trigger profile information at the switching unit, in response to the registration attempt. This is done so as to enable redirection of call control associated with the subscriber to the service node. In an embodiment of the present invention, PLN service node 114 sends the trigger profile information in an update message, such as ISD with trigger profile, upon receiving a receipt of the LUP message at PLN service node 114. Thereafter, at step 206, the service node facilitates completion of the subscriber's registration process in the visited network. In an embodiment of the present invention, PLN service node 114 sends a registration response message, such as LUP-ACK, to VMSC-V/VLR-V 120, in order to complete the ongoing registration process with VPMN 104.

Since the registration has been completed within the VPMN by the PLN service node imitating as HLR for the subscriber's PLN, it is hence not legitimate registration. Hence, it is required for VPMN 104 to verify subscriber 106's identity with HPMN 102, in order to offer him the PLN service. Thus, at step 208, the service node authenticates the subscriber with the home network, using one or more parameters (e.g., IMSI-H and PIN) of the subscriber's profile information. In an embodiment of the present invention, PLN service node 114 authenticates subscriber 106, by retrieving the IMSI-H information from HLR-H 108 and correlating the retrieved IMSI-H with his registered IMSI (i.e. stored at PLN service node 114), at PLN service node 114. In another embodiment of the present invention, PLN service node 114 inquires a PIN from subscriber 106, to verify him as a valid subscriber of HPMN 102. Alternatively, PLN service node 114 authenticates subscriber 106 with his HPMN 102, via FPMN 126. VPMN 104 can also authenticate inbound subscribers (i.e. of HPMN 102) with HPMN 102, who perform a registration attempt at VPMN 104, using a dual IMSI SIM card of HPMN 102. Thus, various one or more parameters, such as authentication triplets and authentication quintuplets, can be retrieved from HPMN 102 to verify subscriber 106 with his HPMN 102. Authentication triplets consists of Rand, Sres, and Kc, whereas authentication quintuplets consists of Rand, Xres, Ck, Ik, and Autn. A detailed call flow for authenticating mechanism is described later in conjunction with FIGS. 4A and 4B, and FIG. 5.

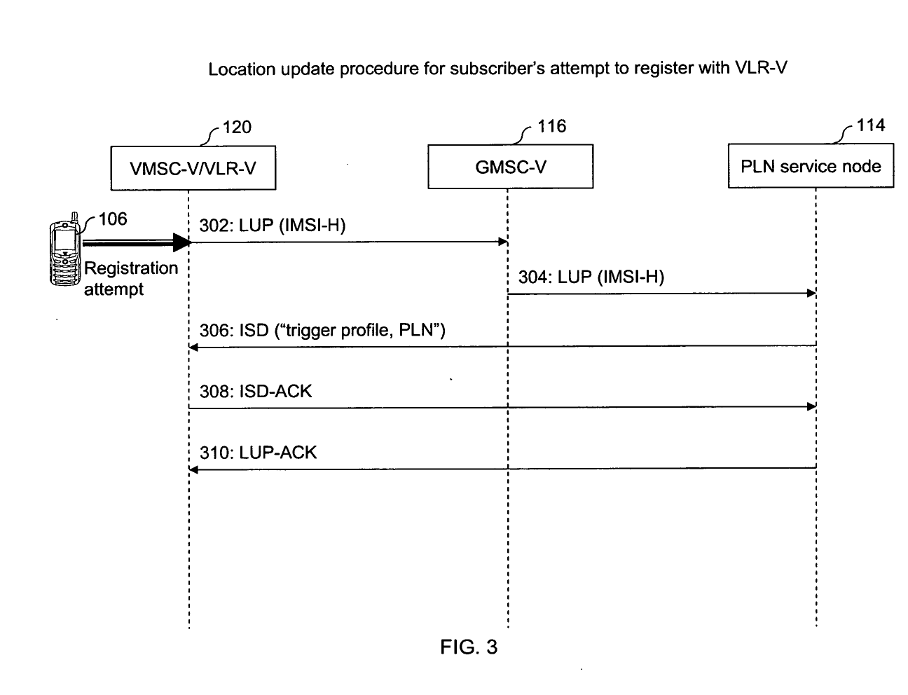

After the authentication procedure is successfully completed and subscriber 106 is allowed to register with VPMN 104, and VPMN 104 thereafter offers the PLN service to subscriber 106 by sending a welcome message to the subscriber's handset (i.e., on his MSISDN-H). In case subscriber 106 accepts this offer, the subscriber's mobile communication is facilitated in VPMN 104, and subscriber 106 can use the PLN to initiate and receive calls and perform SMS and GPRS activities, at local rates. In an embodiment of the present invention, VPMN 104 may also opt to charge calls and SMS on the subscriber's PLN. Thus, in order to avail the PLN service as well as other VAS (e.g., call forwarding, MCA, and SMS forwarding) in VPMN 104, subscriber 106 first needs to register at VPMN 104. FIG. 3 is a flow diagram representing a registration process when the subscriber's handset attempts to register with the VPMN, in accordance with an embodiment of the present invention. Subscriber 106 attempts to register at VPMN 104, thus a registration message (i.e. a location update message) is received at VMSC-V/VLR-V 120. Thereafter, at step 302, VMSC-V/VLR-V 120 sends the LUP message on the IMSI-H to GMSC-V 116 in order to allow subscriber 106 to register with VPMN 104. In addition, as the operator of VPMN 104 has configured GMSC-V 116 to redirect all signaling messages with CdPA=HPMN 102 to PLN service node 114, GMSC-V 116 redirects the received LUP message to PLN service node 114, at step 304. It will be apparent to a person skilled in the art that in case of GPRS, SGSN-V 122, instead of VMSC-V/VLR-V 120, sends a GPRS location update message, such as GPRS-LUP message, to PLN service node 114.

Thereafter, at step 306, since PLN service node 114 has the address of VMSC-V/VLR-V 120 in the subscriber's profile information, PLN service node 114 sends the trigger profile information in an ISD message to VMSC-V/VLR-V 120. Moreover, if the ISD message contains the subscriber's PLN information, the MSISDN-H entry in VMSC-V/VLR-V 120 is updated with the subscriber's PLN. Moreover, PLN service node 114 can send various trigger profile information to VMSC-V/VLR-V 120 that are described later in various embodiments of the present invention. PLN service node 124 sends the trigger profile information using either an ISDN User Part (ISUP) based trigger, an Intelligent Network (IN) based trigger, Advanced Intelligent Network (AIN) based trigger, Wireless Intelligent Network (WIN) based trigger, or a Customized Applications for Mobile network Enhanced Logic (CAMEL) based trigger. For example, if subscriber 106 is a CAMEL subscriber, PLN service node 114 sends Originating CAMEL Subscription Information (O-CSI) to VMSC-V/VLR-V 120, if required. PLN service node 114 may also send T-CSI or SMS-CSI, if VMSC-V/VLR-V 120 requires it for enabling call control to PLN service node 114. In addition, in case of CAMEL subscriber using GPRS service, PLN service node 114 sends local APN and GPRS-CSI instead of O-CSI and SMS-CSI, enabling subscriber 106 to roam using GPRS service in VPMN 104.

After successfully updating the trigger profile information for subscriber 106 at VMSC-V/VLR-V 120, at step 308, VMSC-V/VLR-V 120 sends an update response message, such as ISD-ACK message to PLN service node 114. Finally, at step 310, PLN service node 114 sends a registration response message, such as LUP-ACK, to VMSC-V/VLR-V 120, allowing subscriber 106 to register with VPMN 104. However, since this registration did not involve the authentication of the subscriber, it is considered legitimately incomplete. This verification is required for traceability of unlawful interception and meeting prepaid regulatory requirement of a country. Essentially, VPMN(s) perform the verification of their inbound roaming subscribers, in order to reduce SIM cloning fraud. Moreover, VPMN 104 is required to authenticate subscriber 106, in order to facilitate the subscriber's mobile communication in VPMN 104.

FIGS. 4A and 4B represent a flow diagram for authenticating the subscriber with his home network by a PLN service node coupled to the VPMN, in accordance with a first embodiment of the present invention. After subscriber 106 is successfully registered at VPMN 104, PLN service node 114 sends a first SMS to VMSC-V/VLR-V 120, using MT FwdSMS on the IMSI-H, at step 402. This first SMS inquires the subscriber's MSISDN of HPMN 102 (i.e. MSISDN-H). VMSC-V/VLR-V 120 can thereafter redirect the first SMS to the subscriber's handset to fetch the required MSISDN-H. In an embodiment of the present invention, the first SMS may contain the message content that says, “Thanks for selecting VPMN 104. Here is your VPMN prepaid local number ‘XXX’. You can make calls and send SMS, and receive calls and SMS on this local number provided you top up this account (i.e. either with VPMN 104 scratch card or a credit card or an ATM card). To accept this service and be verified, you must reply to this message with your HPMN 102 number and the pin if you have been given one before”.

Thereafter, at step 404, subscriber 106 acknowledges the first SMS using MT FwdSMS-ACK, via the VMSC-V/VLR-V 120, to PLN service node 114. The operator of VPMN 104 does a configuration at GMSC-V 116 to redirect all MAP signaling messages with E.164 SCCP CdPA as SMSC-H 112 to PLN service node 114. Thus, at step 406, subscriber 106 replies to the first SMS with his MSISDN-H in a second SMS using MO FwdSMS, via VMSC-V/VLR-V 120, to PLN service node 114. Thereafter, at step 408, PLN service node 114 acknowledges receipt of the second SMS using MO FwdSMS-ACK message, to VMSC-V/VLR-V 120. This SMS exchange process (i.e. the first SMS and second SMS exchange) can be termed as a first phase of the subscriber's verification, in accordance with an embodiment of the present invention.

Once the first phase of the subscriber's verification is complete, if there exists SS7 based SMS inter-working between HPMN 102 and VPMN 104 (e.g., when HPMN 102 and VPMN 104 reside in same country), PLN service node 114 sends routing information query to HLR-H 108. Thus, at step 410, PLN service node 114, using the SS7 inter-working relationship, sends a routing information query, such as SRI-SM, on the MSISDN-H to HLR-H 108. Thereafter, at step 412, HLR-H 108 sends an SRI-ACK message to PLN service node 114 and subsequently, PLN service node 114 retrieves the IMSI-H from this SRI-ACK message. Thereafter, at step 414, PLN service node 114 correlates the IMSI stored in the database (that was retrieved from the LUP message), with the IMSI retrieved from the SRI-ACK message (i.e. at step 412). If the correlation reveals that both IMSIs are same, VPMN 104 considers subscriber 106 to be a valid (or verified) subscriber of HPMN 102. For ease of further reference, this IMSIs correlation process is termed as a second phase of the subscriber's verification, in accordance with an embodiment of the present invention. In another embodiment of the present invention, PLN service node 114 may generate a PIN and send this PIN in an SMS to the subscriber's VMSC-V/VLR-V, for further verification of subscriber 106 after executing the second phase. However, this method may be based on the visited network operator's requirement and feasibility.

Alternatively, in case there exists non-SS7 based SMS inter-working between HPMN 102 and VPMN 104, PLN service node 114, at step 416, generates a PIN for subscriber 106 and issues this PIN in a third SMS on to the subscriber's MSISDN-H, using MT FwdSMS on the IMSI-H to VMSC-V/VLR-V 120. However, this message is not delivered to the subscriber's handset unless and until subscriber 106 registers (i.e. manually selects) with HPMN 102 or a roaming partner network of HPMN 102 (which may sponsor HPMN 102). Thereafter, PLN service node 114 sends a fourth SMS to the subscriber's handset containing a message to the effect of: “You must register with your HPMN 102 (or HPMN 102's roaming partner network) to receive an SMS (i.e. third SMS) containing a PIN, and thereafter, you must reply to this SMS (i.e. fourth SMS) with the PIN by registering back with VPMN 104”. PLN service node 114 sends this fourth SMS irrespective of whether or not subscriber 106 has received the third message (i.e. at step 416). Thereafter, at step 418, the subscriber's handset sends an MT FwdSMS-ACK message (i.e. in response to the fourth SMS), to PLN service node 114, via VMSC-V/VLR-V 120.

In an embodiment of the present invention, subscriber 106 may register with HPMN 102 or the roaming partner of HPMN 102 to retrieve the third SMS. Subscriber 106 can note down the received PIN from this third SMS and subsequently re-register with VPMN 104. Thereafter, subscriber 106 sends the retrieved PIN in a fifth SMS to PLN service node 114 during the subscriber's re-registration process. Thereafter, PLN service node 114 correlates the PIN generated for subscriber 106 (i.e. at step 416) with the PIN received in the fifth SMS. If the correlation reveals that the PINs are same, subscriber 106 is considered verified. This confirms that subscriber 106 actually registered with HPMN 102 to retrieve the PIN sent in fifth SMS. Fifth SMS and the subsequent PIN correlation steps are not shown in FIGS. 4A and 4B. Steps 416 and 418 can be referred to as a PIN verification process for subscriber 106, in accordance with an embodiment of the present invention.

In accordance with another embodiment of the present invention, a combination of first phase verification, the second phase verification, and the PIN verification process may be used as an alternate solution for verifying the subscribers of HPMN 102, who attempt to register at VPMN 104. Once subscriber 106 is verified, PLN service node 114, at step 420, stores the mapping records of IMSI-H, MSISDN-H, PLN, IMSI-V, and VLR-V/VMSC-V, provided any of these records have not been stored previously.

Thereafter, at step 422, PLN service node 114 sends a sixth SMS (using MT FwdSMS on the IMSI-H) to subscriber 106 via VMSC-V/VLR-V 120, to indicate successful verification of subscriber 106. In an embodiment of the present invention, PLN service node 114 sends the sixth SMS with the following message content: “You have been verified and accepted to use the PLN service in VPMN 104. Your authentication PIN is ‘xxx’. Please keep this pin in a safe place for possible future verification”. Finally, at step 424, the subscriber's handset acknowledges the sixth SMS using MT FwdSMS-ACK message, via VMSC-V/VLR-V 120, to PLN service node 114. In an embodiment of the present invention, after successful verification of subscriber 106 using the sixth SMS, PLN service node 114 may send a standalone ISD message to VMSC-V/VLR-V 120 to update VMSC-V/VLR-V 120 with the MSISDN-H. This allows MSISDN-H to be displayed as a caller ID (i.e. on the called party's handset) for every MO activity (i.e. calls and SMS) performed by subscriber 106 using his PLN.

In various embodiments of the present invention, the operator of VPMN 104 may configure PLN service node 114 in order to perform these verification procedures, for a pre-defined number of times at a configurable time interval. For example, PLN service node 114 may verify subscriber 106 each time a new location update is detected (e.g., at VMSC-V/VLR-V 120) from subscriber 106 at PLN service node 114. In another example, PLN service node 114 may verify subscriber 106 after a configurable number of location updates, or after a configurable time interval. In yet another example, PLN service node 114 may randomly verify subscriber 106, on detecting any location update, using a random algorithm. These configurations are based upon the requirement of VPMN 104 operator.

In order to avoid fraud control, VPMN 104 may opt to inquire the PIN from subscriber 106 in any random verification with subscriber 106, in accordance with an embodiment of the present invention. For cloning a SIM of subscriber 106, the person cloning the subscriber 106's SIM would need to know both the MSISDN and the PIN associated with the subscriber 106's SIM. However, with this random inquiry, it is quite unlikely to clone the SIM. Moreover, a law authority can perform lawful interception to trace subscriber 106 by providing (or sending) the subscriber's PLN and the IMSI-H to VMSC-V/VLR-V 120 (or SGSN-V 122). Moreover, the law authority can determine the subscriber's current location (i.e. in VPMN 104), by sending a query message, such as an SRI, to PLN service node 114. As PLN service node 114 contains the VMSC-V/VLR-V address of subscriber 106, it can return this information to the law authority in response to its query message.

Various verification procedures described above require the operator of VPMN 104 to configure PLN service node 114, in order to send various messages to HLR-H 108, or VMSC-V/VLR-V 120, or both. Alternatively, VPMN 104 may use FPMN 126 (as shown in FIG. 1) as a sponsoring network of VPMN 102 to facilitate subscriber 106's authentication with HPMN 102. This technique does not require VPMN 104 to send any SMSs to HLR-H 108 or VMSC-V/VLR-V 120, or both; instead, it relies on its roaming relationship with the sponsoring network that also has a roaming agreement with HPMN 102. Moreover, number of configurations that are done at various components of VPMN 104 (i.e. for sending various messages) are reduced in this approach of subscriber verification.

FIG. 5 is a flow diagram for authenticating the subscriber by the PLN service node with his home network via a sponsoring network, in accordance with a second embodiment of the present invention. At step 502, VMSC-V/VLR-V 120 sends an authentication request, such as Send Authentication Information (SAI), for the IMSI-H to PLN service node 114. PLN service node 114 maintains the mapping records of the VMSC/VLR address (i.e. VMSC-V/VLR-V 120) from the SAI message. The operator of VPMN 104 does a configuration at PLN service node 114, to redirect selected signaling messages, such as SendAuthenticationInformation (SAI) with CdPA as IMSI of HPMN 102, to RR-F 130. Thus, at step 504, PLN service node 114 redirects the received SAI message to RR-F 130, by changing the CgPA with a GT and an SPC of PLN service node 114. Thereafter, at step 506, RR-F 130 further relays the SAI message to HLR-H 108, in order to retrieve authentication parameters that are required to authenticate subscriber 106 with his HPMN 102. HLR-H 108 will accept the SAI message from RR-F 130, as FPMN 126 has a roaming agreement with HPMN 102. It will be apparent to a person skilled in the art that if subscriber 106 is a GSM subscriber, HLR-H 108 will return authentication triplets; however, if subscriber 106 is an UMTS subscriber, HLR-H 108 will return authentication quintuplets.

Further, at step 508, HLR-H 108 sends various authentication parameters in an SAI-ACK message to RR-F 130. Thereafter, RR-F 130, at step 510, sends the SAI-ACK message with the authentication parameters to PLN service node 114. PLN service node 114 can store these authentication parameters in its database for any subsequent authentication of its inbound roaming subscribers. Henceforth, PLN service node 114 may use these authentication parameters to authenticate subscriber 106 for a predefined number of attempts. Thus, whenever subsequent verification of subscriber 106 is required, PLN service node 114 provides the required information from its database, instead of re-retrieving the authentication parameters from HLR-H 108. Finally, at step 512, PLN service node 114 further relays the SAI-ACK message to VMSC-V/VLR-V 120. In this case, VPMN 104 successfully authenticates subscriber 106 with his HPMN 102 via sponsoring network 126, without requiring subscriber 106 to possess roaming profile support at HLR-H 108. This is especially useful in cases, where most prepaid and even some postpaid subscribers do not possess roaming profiles. For example, in South America, over 90 percent of subscribers are prepaid.

In one embodiment of the present invention, subscriber 106 may use a dual IMSI SIM of HPMN 102, and HPMN 102 may use a partner network that sponsors HPMN 102, to facilitate the subscriber 106's authentication. The partner network is an optional system element, which is used only in dual IMSI SIM case to authenticate subscriber 106 with his HPMN 102. In this case, VPMN 104 authenticates subscriber 106, when subscriber 106 uses a roaming IMSI (i.e. IMSI of the partner network) to register at VPMN 104. However, the only change in this case of the dual IMSI SIM card is that messages like, SAI (and the SAI-ACK), would now be relayed through an RR coupled to the partner network, in addition to RR-F 130 (i.e. present in FPMN 126). In other words, the messages originating from VPMN 104 will first be intercepted at RR-F 130, which then further relays it to HPMN 102 via the RR coupled to the partner network.

Since subscriber 106 is registered with VPMN 104 and using the PLN in VPMN 104, he is essentially like a prepaid subscriber of VPMN 104, despite having a SIM of HPMN 102. In various embodiments of the present invention, VPMN 104 allows subscriber 106 to receive calls on his MSISDN-H, in addition to receiving calls on his PLN. This can be achieved either by forwarding calls received on his MSISDN-H to the PLN of subscriber 106, or by subscriber 106 opting to receive MCA on his handset, upon receiving calls on his MSISDN-H. FIGS. 6A and 6B represent a flow diagram of forwarding a Mobile Terminated (MT) call, received on the subscriber's HPMN MSISDN to the subscriber's PLN in the VPMN, in accordance with an embodiment of the present invention.

There may be a case when SS7 inter-working exists between HPMN 102 and VPMN 104. For instance, SS7-based SMS inter-working may exist between national operators (i.e. HPMN 102 and VPMN 102 are national operators). In such a case, PLN service node 114 can send a MAP RegisterSS message with Call Forwarding Unconditional (CFU) as the PLN (i.e. CFU=PLN), along with the subscriber's IMSI-H to HLR-H 108. As unconditional call forwarding is set at HLR-H 108, thus all MT calls to the subscriber's MSISDN-H are forwarded to his PLN. At step 602, when a calling party ‘B’ originates a call to the subscriber's MSISDN-H, the call request IAM (B, MSISDN-H) is received at GMSC-H 110 (i.e. subscriber's home GMSC). Thereafter, at step 604, GMSC-H 110 sends a routing information query, such as SRI, on the MSISDN-H to HLR-H 108. As subscriber 106 has subscribed to call forwarding at his HPMN 102 (i.e. at HLR-H 108), at step 606, HLR-H 108 sends PLN as a Forward-To-Number (FTN) in an SRI-ACK message. Thereafter, at step 608, GMSC-H 110 routes the call request IAM (B, OCN=MSISDN-H, PLN) to GMSC-V 116, with Originally Called Number (OCN) as MSISDN-H along with the subscriber's PLN as FTN.

Now, in order to allow subscribers to receive calls on their respective PLNs, the operator of VPMN 104 configures GMSC-V 116 to send a routing information query, such as Send Routing Information (SRI) message, for all calls received on these PLNs, to PLN service node 114. This allows PLN service node 114 to retrieve a roaming number, such as a Mobile Station Roaming Number (MSRN), corresponding to a PRN request on the PLN from VMSC-V/VLR-V 120. Thus, at step 610, GMSC-V 116 forwards the SRI (PLN) message to PLN service node 114. Thereafter, at step 612, PLN service node 114 sends a PRN request on the IMSI-H to VMSC-V/VLR-V 120. Thereafter, at step 614, VMSC-V/VLR-V 120 returns an MSRN in a PRN-ACK message to PLN service node 114. Upon receiving the PRN-ACK message, PLN service node 114 sends the MSRN and IMSI-V in an SRI-ACK message to GMSC-V 116, at step 616. Finally, at step 618, GMSC-V 116 initiates a call on the MSRN, i.e. LAM (B, MSRN) to VMSC-V/VLR-V 120. Thus, eventually the call is connected between calling party ‘B’ and subscriber 106's MSRN. Hence, subscriber 106 is able to receive calls, intended for his MSISDN-H, on to his PLN.

Alternatively, the subscribers can opt to receive MCA on their respective PLNs, in order to avoid the call forwarding costs that are levied by HPMN 102. FIGS. 7A and 7B represent a flow diagram of sending a missed call alert to the subscriber's PLN, and a calling party originating a call, when the call is received on the subscriber's HPMN MSISDN, in accordance with an embodiment of the present invention. Subscriber 106 can activate the MCA service by calling customer care, or by using MMI (i.e. when registered with HPMN 102) to send an MCA on his PLN, and optionally, on the calling party's handset (originating the call). Hence, when a calling party ‘B’ originates a call to the subscriber's MSISDN-H, at step 702, the call request IAM (B, MSISDN-H) is received at GMSC-H 110, which is the subscriber's home GMSC. Thereafter, at step 704, GMSC-H 110 sends a routing information query, such as SRI, on the MSISDN-H to HLR-H 108. As subscriber 106 has requested (or subscribed) for the MCA service at HLR-H 108, at step 706, HLR-H 108 sends a FTN, i.e., a Prepaid Service Node number (i.e. PSN#), to GMSC-H 110 in an SRI-ACK message. PSN# number corresponds to a PLN phone number that is provided by HLR-H 108, when subscriber 106 has subscribed to the MCA services. Thereafter, at step 708, GMSC-H 110 routes IAM (B, OCN=MSISDN-H, PSN#) to GMSC-V 116 with OCN as MSISDN-H (i.e. OCN=MSISDN-H) along with the subscriber's PLN as the FTN (i.e. FTN=PLN).

Further, the operator of VPMN 104 configures GMSC-V 116 to redirect all MT calls on the special PLN (i.e. PSN#), that are received at GMSC-V 116, to PLN service node 114. Thus, at step 710, GMSC-V 116 routes IAM (B, OCN=MSISDN-H, PSN#) to PLN service node 114. Thereafter, at step 712, PLN service node 114 stores the calling party ‘B’ number and the OCN (i.e. the subscriber's MSISDN-H) in its database. Thereafter, at step 714, PLN service node 114 releases the ongoing call (i.e. IAM (B, PSN#)), by sending a release message, such as REL, to GMSC-H 110. PLN service node 114 releases this call based on the configuration done at PLN service node 114 to release any call received on the PSN#.

Thereafter, at step 716, PLN service node 114 sends a first MCA in an SMS (i.e. via VMSC-V/VLR-V 120), such as MT FwdSMS with the IMSI-H, to the subscriber's PLN. Alternatively, PLN service node 114 can send an USSD alert to the subscriber's PLN. In an embodiment of the present invention, this message may contain the following message content: “A call from <calling party B#> to your <MSISDN-H> is missed at time ‘T’ and date ‘D’”. Thereafter, at step 718, the subscriber's handset returns an acknowledgement message, such as MT FwdSMS-ACK, to PLN service node 114 (i.e. via VMSC-V/VLR-V 120). Thereafter, as subscriber 106 now has the calling party ‘B’ number and the time of call being displayed on his handset, subscriber 106 can call back the calling party ‘B’, using his PLN. This approach is cheaper (since calls are made at local rates as applicable in VPMN 104), as compared to call forwarding approach. In an embodiment of the present invention, the calling party ‘B’, instead of PLN service node 114, sends an SMS (i.e. at step 716) in the form of the first MCA to the subscriber's PLN, that triggers the subscriber's phone book entry (i.e. stores the calling party number in the subscriber's handset). This will be advantageous, as subscriber 106 may call back (or even send a reply SMS) the calling party B's number using his PLN. Moreover, subscriber 106 will be charged for this call or SMS at local rates, applicable in VPMN 104.

Finally, at step 720, if the calling party ‘B’ is a mobile handset, PLN service node 114 sends a second MCA in an SMS, to the calling party ‘B’. It will be apparent to a person skilled in the art that this message is first sent to an SMSC of the calling party ‘B’, which will relay this message to the calling party B's handset. In an embodiment of the present invention, the second MCA sent to the calling party ‘B’ displays the subscriber 106's PLN on the B's handset. Thus, the calling party ‘B’ may call back subscriber 106 on his PLN. The MCA service offers an advantage to subscriber 106 in VPMN 104, in a way that it prevents the call forwarding charges, which are charged in case subscriber 106 sets call forwarding on his MSISDN-H to his PLN.

VPMN 104 may charge subscriber 106 for the MCA service either on monthly basis (i.e. deducting an amount from the subscriber's prepaid account on monthly basis), or may charge subscriber 106 for every MCA message that is sent to his PLN (and to the calling party ‘B’, if opted). Thus, providing the MCA service to its subscribers helps VPMN 104 increase its revenues. In one case, when the calling party ‘B’ calls the subscriber's PLN, subscriber 106 may not be charged for this call (i.e. in case VPMN 104 does not charge MT calls on the subscriber's PLN). However, VPMN 104 may choose to earn revenue by charging the MT calls on the subscriber's PLN. At the same time, HPMN 102 can earn revenue from this MCA service, only if the calling party ‘B’ is a subscriber of HPMN 102.

Various embodiments for calls on the subscriber's PLN when the subscriber is not charged for these calls are described earlier in conjunction with FIGS. 6A and 6B. However, there may be a case when subscriber 106 is not registered with VPMN 104, and a calling party ‘B’ calls his PLN. For example, subscriber 106 may have visited VPMN 104 earlier and subscribed to the PLN service, where he chose to take a PLN for one month. However, in between this period, subscriber 106 may not always be registered at VPMN 104, as he may move out of VPMN 104. Hence, during that unregistered phase, when a call is received at the subscriber's PLN, PLN service node 124 determines a special number (S#) corresponding to the subscriber's PLN, and releases the ongoing call.

FIG. 8 is a flow diagram of sending a special number (S#) by the PLN service node upon receiving MT call on the subscriber's PLN, when the subscriber is not registered with the VPMN, in accordance with an embodiment of the present invention. At step 802, GMSC-V 116 receives a call request IAM (B, PLN) for call on the subscriber's PLN. As per the configuration done at GMSC-V 116 (i.e. described in FIGS. 6A and 6B), GMSC-V 116 sends the SRI message on the PLN to PLN service node 114, at step 804. Thereafter, at step 806, PLN service node 114 returns the special number (S#) corresponding to the PLN to GMSC-V 116. In this embodiment, when PLN service node 114 receives the SRI message for the PLN, it does not send any PRN message to VMSC-V/VLR-V 120. This is because PLN service node 114 has no VMSC/VLR address for the called PLN in its database, as subscriber 106 is currently not registered with VPMN 104. Further, at step 808, GMSC-V 116 routes the call (for example via ISUP loopback) on the S# by sending LAM (B, S#) to PLN service node 114. ISUP loopback corresponds to an ISUP trunk that originates and terminates at the same Service Switching Point (SSP). Using ISUP loopback, network operators provide an intelligent routing to the SS7 infrastructure as the trunks required for the call setup is largely reduced. Since PLN service node 114 identifies subscriber 106 as not being registered at VPMN 104, PLN service node 114 releases the call request on the PLN by sending a release message, such as REL, at step 810.

In an embodiment of the present invention, PLN service node 114 may provide a special cause for releasing the call to VMSC-V/VLR-V 120. Since GMSC-V 116 sends an ISUP loopback call control to PLN service node 114 (i.e. at step 808), in a normal scenario, this call control should be ISUP out to the SSP (i.e. VMSC-V/VLR-V 120). However, in this embodiment, PLN service node 114 releases the ongoing call instead of ISUP out to VMSC-V/VLR-V 120, thus PLN service node 114 must send some indication, such as the special cause for releasing the ISUP call, to VMSC-V/VLR-V 120. The ISUP out corresponds to sending out the call control from one switching node (i.e. PLN service node 114) to another switching node (i.e. prepaid service node). Moreover, PLN service node 114 may send a first MCA message to the subscriber's PLN. This message will be delivered to the subscriber's handset on his PLN, when subscriber 106 registers (and uses the PLN in VPMN 104) back at VPMN 104. Hence, at step 812, PLN service node 114 sends the first MCA message on the subscriber's PLN indicating that the call was made to his PLN. It may further displays the calling party B's number and the time of call, at the subscriber's handset. Finally, at step 814, if the calling party ‘B’ is also a mobile number, PLN service node 114 sends a second MCA as an SMS to the calling party B's handset. In another embodiment of the present invention, when no MCA is to be sent to either subscriber 106 or the calling party ‘B’, and subscriber 106 is not registered at VPMN 104, PLN service node 114 sends an absent subscriber message in an SRI-ACK message to GMSC-V 116, upon receiving the SRI message on the PLN from GMSC-V 116.

It will be apparent to a person skilled in the art that IN applications can be implemented on Service Control Points (SCPs), and the call setup is performed using ISUP signaling. Various vendors are implementing switch triggers needed for the prepaid services. For example, Ericsson provides a DP12 trigger control profile that can be used in the prepaid services for sending the terminating trigger profile information to various switching units. It will be apparent to a person skilled in the art that an origination trigger can interrupt an ongoing call processing and then route that call to a prepaid SCP that performs a check for the subscriber's balance. If only there is sufficient balance for the subscriber to make a call, the prepaid SCP informs VMSC-V/VLR-V to further process the call. Otherwise, the switch releases the call. Similarly, for charging the MT calls by VPMN 104, there also exists terminating triggers that can interrupt the ongoing call processing and inquire the prepaid SCP for the subscriber's current balance amount, and accordingly inform the VMSC-V/VLR-V to terminate the call.

Some network operators (e.g. VPMN 104) may choose to charge subscriber 106 for MT calls on the subscriber's PLN. In such cases, the switch (i.e. the GMSC handling the terminating call) needs a terminating trigger to appropriately bill and terminate the call. FIGS. 9A and 9B represent a flow diagram of sending a terminating trigger profile by the PLN service node upon receiving MT call on the subscriber's PLN, where the VPMN charges the MT calls received on the subscriber's PLN, in accordance with a first embodiment of the present invention. If subscriber 106 is an IN/CAMEL subscriber, then in order to perform billing/charging at a prepaid SCP in VPMN 104, PLN service node 114 needs to send terminating trigger profile information to GMSC-V 116. Additionally, it will be apparent to a person skilled in the art that as VPMN 102 is providing the PLN service to its inbound subscribers, only prepaid billing is considered, irrespective of whether the inbound subscribers are postpaid or prepaid.

When the calling party ‘B’ originates a call on the subscriber's PLN, GMSC-V 116 receives a call request IAM (B, PLN), at step 902. Thereafter, at step 904, GMSC-V 116 sends the SRI message to PLN service node 114. As PLN service node 114 has the terminating trigger profile information, such as T-CSI or any DP12 trigger control profile, it returns this information and an IMSI-V (i.e. IMSI corresponding to the subscriber's PLN) in the SRI-ACK message to GMSC-V 116, at step 906. The terminating trigger enables GMSC-V 116 to sends an Intelligent Network Application Part (INAP) Initial Detection Point (IDP) message (which is an IN/CAP message) with the calling party ‘B’ number, the PLN, the IMSI-V, and the GMSC-V address to a prepaid SCP 907, at step 908. In an embodiment of the present invention, GMSC-V 116 can relay the IDP message to prepaid SCP 907, via PLN service node 114 in the active monitoring mode. IDP message consists of call information, subscriber's location information, and Service Switching Function (SSF) capabilities. It will be apparent to a person skilled in the art that the SSF corresponds to a set of processes that are performed in IN/CAMEL, and provides a communication path between Call Control Function (CCF) and Service Control Function (SCF).

Moreover, when VMSC-V/VLR-V 120 detects a trigger, the call processing at VMSC-V/VLR-V 120 is temporarily held. After prepaid SCP 907 determines sufficient balance to process the ongoing MT call on the PLN, at step 910, prepaid SCP 907 sends an IN/CAP RRB Connect or Continue message to GMSC-V 116 to answer the ongoing call on the PLN. In an embodiment of the present invention, prepaid SCP 907 sends the RRB Continue request to GMSC-V 116 via PLN service node 114 to answer the call. Thereafter, the call processing that was temporarily paused resumes. In case when the subscriber's prepaid account (corresponding to his PLN) does not have sufficient balance to process the call on his PLN, PLN service node 114 sends the RRB request to GMSC-V 116 to disconnect the ongoing call. In another embodiment of the present invention, prepaid SCP 907 determines that the terminating trigger was not required and hence, prepaid SCP 907 sends (i.e. at step 910) a CAP Continue message to GMSC-V 116 that informs VMSC-V/VLR-V 120 to continue the call processing. In this embodiment, at step 912, GMSC-V 116 sends another SRI message on the PLN to PLN service node 114. Thereafter, at step 914, PLN service node 114 sends a PRN request message to VMSC-V/VLR-V 120 to obtain a roaming number corresponding to the PLN. Thereafter, at step 916, VMSC-V/VLR-V 120 returns an MSRN corresponding to the PLN, to PLN service node 114. At step 918, PLN service node 114 sends the MSRN and the IMSI-V information in the SRI-ACK message to GMSC-V 116. Further, at step 920, GMSC-V 116 initiates a call setup using IAM (B, MSRN) to VMSC-V/VLR-V 120. Once the call is answered, at step 922, GMSC-V 116 sends an IN/CAP Event Report BCSM (ERB) to prepaid SCP 907 to begin timing counter for charging subscriber 106 for the MT call on his PLN. In another embodiment of the present invention, GMSC-V 116 sends the IN/CAP ERB to prepaid SCP 907, by relaying through PLN service node 114. When subscriber 106 or the calling party ‘B’ disconnects the call, prepaid SCP 907 stops the timing counter and accordingly the balance is deducted from the prepaid account of subscriber 106. Finally, at step 924, prepaid SCP 907 releases the call on the PLN by sending an IN/CAP ReleaseCall message to GMSC-V 116.

MT calls on the subscriber's PLN can also be handled when PLN service node 114 does not send any terminating trigger profile information to VMSC-V/VLR-V 120. FIG. 10 represents a flow diagram of sending the special number (S#) by the PLN service node upon receiving the MT call on the subscriber's PLN, where the VPMN charges the MT calls received on the subscriber's PLN, in accordance with a second embodiment of the present invention. As, in this case PLN service node 114 does not send any terminating trigger to GMSC-V 116, VPMN 104 may rely upon the tying up of a trunk during call setup. This means that the call is setup using a transmission channel between two nodes, such as switching centre(s) or switching nodes. For instance, in a normal call scenario, an IAM call is set up by forming a trunk between an originating GMSC/STP and a terminating GMSC/STP. A calling party ‘B’ calls subscriber 106 at his PLN. Thus, at step 1002, GMSC-V 116 receives a call request IAM (B, PLN) from the calling party ‘B’. Thereafter, at step 1004, GMSC-V 116 sends the SRI message to PLN service node 114. PLN service node 114 retrieves a special PLN (S#), corresponding to the subscriber's PLN from a pool of pre-defined local numbers. Thus, at step 1006, PLN service node 114 sends the retrieved S# in the SRI-ACK message to GMSC-V 116. Thereafter, at step 1008, GMSC-V 116 routes the call control IAM (B, S#), via an ISUP loopback to PLN service node 114. PLN service node 114 determines the PLN corresponding to the S#, and ISUP out the call control IAM (B, PLN) to a prepaid service node 1009, at step 1010. PLN service node 114 changes the called party number from the S# to the PLN, in order to connect the call between the calling party ‘B’ and the subscriber's PLN.

The functionalities of prepaid service node 1009 in ISUP based call setup corresponds to that of prepaid SCP 907 in IN/CAP. Prepaid service node 1009 checks for the subscriber's current balance (i.e. in his prepaid account) and based on this information, it allows further processing of call and non-call related activities. At step 1012, prepaid service node 1009, acting as a switch, sends the Address Completion Message (ACM) to PLN service node 114, which at step 1014, relays the ACM to GMSC-V 116, in order to confirm that the trunks are reserved for the call setup.

Further, at step 1012 and 1014, prepaid service node 1009 relays Answer Message (ANM) to GMSC-V 116 via PLN service node 114. Once prepaid service node 1009 sends the ANM, it begins the prepaid billing for the subscriber's PLN. Thereafter, if either the calling party ‘B’ or the called PLN subscriber 106 disconnects the call, prepaid service node 1009, at step 1016, stops the billing and releases the call on the PLN by sending an REL message to PLN service node 114. Finally, at step 1018, as subscriber 106 has disconnected the ongoing call, PLN service node 114 relays the REL message to GMSC-V 116, to release the trunk for the call setup. In an embodiment of the present invention, when the prepaid account of subscriber 106 is less than the minimum value required for the call, prepaid service node 1009 relays the REL message to GMSC-V 116 via PLN service node 114, in order to disconnect the ongoing call and the trunk required for the call setup.

As described above, VPMN 104 may charge subscriber 106, who is using his PLN to initiate calls, as per the local charges applicable in VPMN 104. FIG. 11 represents a flow diagram of Mobile Originated (MO) call from the subscriber's handset using an ISUP-based trigger, in accordance with an embodiment of the present invention. Subscriber 106 can originate calls using his PLN at local rates. Subscriber 106 originates a call from his PLN to a called party ‘B’. The call reaches VMSC-V/VLR-V 120, which sends the call control ISUP (A, B) (for example, via an ISUP loopback) to PLN service node 114, at step 1102. In an embodiment of the present invention, the called party ‘B’ is a prefixed number ‘C’ (i.e. prefix-C). In this case, VMSC-V/VLR-V 120, instead of GMSC-V 116 (i.e. in FIG. 8 and FIG. 10), sends the ISUP loopback to PLN service node 114. Additionally, subscriber 106 may initiate calls to a prefix number before the called party ‘B’ number. PLN service node 114 then ISUP outs the call control to prepaid service node 1009. Thus, at step 1104, PLN service node 114 sends ISUP (A, B) to prepaid service node 1009. In an embodiment of the present invention, PLN service node 114 may send call control ISUP (A, C) to prepaid service node 1009, if B corresponds to a prefixed number C.

Thereafter, at step 1106, prepaid service node 1009 sends an ACM to PLN service node 114. Further at step 1108, PLN service node 114 relays it to VMSC-V/VLR-V 120, in order to confirm that the trunks are reserved for the call setup. At step 1110, prepaid service node 1209 sends an answer message like ANS to PLN service node 114, and henceforth it begins the prepaid billing for the subscriber's PLN. Thereafter, at step 1112, PLN service node 114 relays the ANS to VMSC-V/VLR-V 120. Now, if either the called party ‘B’ or the calling party PLN subscriber 106 disconnects the call, prepaid service node 1009, at step 1114, stops the billing and releases the call on the called party ‘B’, by sending an REL message to PLN service node 114. Finally, at step 1116, PLN service node 114 relays the REL message to VMSC-V/VLR-V 120 to release the trunk for the call setup. In an embodiment of the present invention, when the prepaid account of subscriber 106 is less than the minimum value required for the call, prepaid service node 1009 relays the REL message to VMSC-V/VLR-V 120 via PLN service node 114, in order to disconnect the ongoing call and the corresponding trunk.

In accordance with another embodiment of the present invention, the MO call procedure for IN/CAMEL based trigger is similar to the ISUP based trigger explained above. However, the messages corresponding to IN protocol will be used to follow call flow of the MO call in FIG. 11. Hence, various signaling messages like ISUP, ACM, ANS, and REL (i.e. in the ISUP based triggers) correspond to IDP, RRB, ERB, and ReleaseCall message (i.e. in the IN/CAMEL based triggers), respectively. In the IN/CAMEL based trigger approach for MO calls, VMSC-V/VLR-V 120 sends the IDP message to PLN service node 114 with the IMSI-H, the PLN, the called party ‘B’ number (i.e. B#), and the VMSC-V/VLR-V address. Thereafter, PLN service node 114 sends the IDP message to prepaid SCP 907 with the IMSI-V, the PLN, the B#, and the VMSC-V/VLR-V address. It will be apparent to a person skilled in the art that prepaid service node 1009 in the ISUP based trigger approach is replaced with prepaid SCP 907 in the IN based trigger approach.

Subscriber 106 can also send SMS using his PLN at local rates as applicable in VPMN 104. FIG. 12 represents a flow diagram of MO Short Message Service (SMS) from the subscriber's handset without Customized Applications for Mobile network Enhanced Logic (CAMEL) or IN equivalent support, by interfacing with a prepaid SCP, in accordance with an embodiment of the present invention. Subscriber 106 sends an SMS to the called party ‘B’ using his PLN. This SMS is received at VMSC-V/VLR-V 120, which initiates the MO SMS procedure for sending the SMS to the called party ‘B’. As per the configuration done at GMSC-V 116 (i.e. described in FIGS. 4A and 4B), VMSC-V/VLR-V 120, at step 1202, sends an FwdSMS message on the called party ‘B’ number (i.e. via GMSC-V 116) with the IMSI-H, the PLN, the SMSC-H address, and the VMSC-V/VLR-V address to PLN service node 124. PLN service node 114 interfaces prepaid SCP 907 for checking and deducting the balance from the subscriber's prepaid account. Thus, at step 1204, PLN service node 114 sends various message parameters to prepaid SCP 907 for checking and deducting the balance from the subscriber's prepaid account.

Thereafter, at step 1206, prepaid SCP 907 returns a confirmation message to PLN service node 114 for the amount that is successfully deducted for the MO SMS. In an embodiment of the present invention, when there is insufficient balance in the subscriber's prepaid account, prepaid SCP 907 returns an error message to PLN service node 114. In this embodiment, PLN service node 114 returns FwdSMS-ACK message with an error message, such as system failure, to VMSC-V/VLR-V 120. By sending this error message, PLN service node 114 ensures that the SMS is not re-delivered. In addition, PLN service node 114 may also send a (MT) FwdSMS message on the subscriber's PLN to remind subscriber 106 to top up his prepaid account in order to resend the failed SMS.

However, if the subscriber's prepaid account has a sufficient balance to send the SMS to the called party ‘B’, the amount is deducted and an acknowledgement is returned to PLN service node 114 for indicating successful deduction from the subscriber's prepaid account. Thereafter, at step 1208, PLN service node 114 modifies the MO FwdSMS message on B# with IMSI-V, PLN, VMSC-V/VLR-V address, and SMSC-V address, and sends it to SMSC-V 118. PLN service node 114 modifies and sends the MO FwdSMS message with IMSI-V in order to redirect messages to SMSC-V 118, instead of SMSC-H 112 with the IMSI-H. This is done since VPMN 104 has NRA with HPMN 102, and HPMN 102 will reject any signaling messages received directly from VPMN 104. Thereafter, SMSC-V 118 returns FwdSMS-ACK message to PLN service node 114, at step 1210. Finally, at step 1212, PLN service node 114 relays the FwdSMS-ACK message to VMSC-V/VLR-V 120. Thus, subscriber 106 is able to send the SMS to the called party ‘B’ at local rates applicable in VPMN 104.

Further, in accordance with another embodiment of the present invention, the MO SMS procedure, with IN/CAMEL support is similar to the MO SMS procedure, without IN/CAMEL support as explained above. However, when CAMEL/IN support is present, similar messages will be used to follow the call flow of MO SMS as in FIG. 12. Hence, various message parameters like IMSI-H, PLN, B#, SMSC-H address and VMSC-V/VLR-V address (i.e. used in MO SMS with CAMEL/IN support case) are same as MO SMS without CAMEL/IN support case (as shown in FIG. 12). In the MO SMS case with IN/CAMEL support, VMSC-V/VLR-V 120 sends an IDP SMS to PLN service node 114 on B# with IMSI-H, PLN, SMSC-H address, and VMSC-V/VLR-V address. Thereafter, PLN service node 114 modifies the IDP SMS with IMSI-V, PLN, the SMSC-V address, and the VMSC-V/VLR-V address, and sends it to prepaid SCP 907 on the S#. Prepaid SCP 907 sends an IN/CAP RRB ConnectSMS or ContinueSMS message to VMSC-V/VLR-V 120, via PLN service node 114, to answer the SMS. VMSC-V/VLR-V 120 relays an ERB-SMS to prepaid SCP 907 via PLN service node 114. The ERB-SMS message indicates an event that the SMS from the subscriber's PLN has been received, and hence charging/deducting from the subscriber's prepaid account can be performed. Therefore, prepaid SCP 907 sends ReleaseSMS, ContinueSMS, and ConnectSMS to VMSC-V/VLR-V 120 via PLN service node 114 based on the credit balance in the subscriber's prepaid account. If subscriber 106 has sufficient balance in his prepaid account, the SMS is forwarded, otherwise, prepaid SCP 907 drops the SMS.

In accordance with an embodiment of the present invention, subscriber 106 may be an inbound GPRS roamer, and hence subscriber 106 can exchange data and voice signaling in VPMN 104. If VPMN 104 allows subscriber 106 to GPRS roam in VPMN 104, subscriber 106 can establish a PDP context with GGSN-V 124. In some cases, subscriber 106 may or may not be a CAMEL subscriber. FIG. 13 represents a flow diagram of MO General Packet Radio Service (GPRS) from the subscriber's handset without CAMEL or IN equivalent support by interfacing with the SCP, in accordance with an embodiment of the present invention. Various steps in the MO GPRS call flow follows that of the previous “RR piggyback” filing. However, in order to allow subscriber 106 to use these services, the operator of VPMN 104 configures a Domain Name Server (DNS) in SGSN-V 122, to map all messages with the APN of HPMN 102, to PLN service node 114. Additionally, PLN service node 114 can maintain a mapping, between the APN of HPMN 102 and an APN of VPMN 104, in its database. PLN service node 114 acts as a GGSN in VPMN 104, which maps all messages with the APN of HPMN 102 to itself. Thus, subscriber 106 is charged at local rates as applicable in VPMN 104. Subscriber 106 may also send one or more SMS using GPRS services in VPMN 104, in accordance with the present invention. When subscriber 106 requests for PDP session, then a PDP context is established at SGSN-V 122. Thus, at step 1302, SGSN-V 122 sends a PDP action on the subscriber's PLN with APN of HPMN 102 and the IMSI-H to PLN service node 114. APN of HPMN 102 corresponds to APN-H, in accordance with an embodiment of the present invention. Thereafter, at step 1304, PLN service node 114 interfaces prepaid SCP 907 to check and deduct the credit amount from the subscriber's prepaid account, using APN-H. Thereafter, at step 1306, prepaid SCP 907 returns an acknowledgement message to confirm deduction of credit amount from the subscriber's prepaid account. In this case, subscriber 106 is charged (i.e. deduction of amount from the subscriber's prepaid account) for initiating the GPRS activity in VPMN 104.

Once the initiation amount is successfully deducted from the subscriber's prepaid account, PLN service node 114 modifies the PDP action on the PLN with an APN of VPMN 104 and IMSI-V, at step 1308. APN of VPMN 104 is interchangeably referred to as APN-V. It will be apparent to a person skilled in the art that the MO GPRS flows and embodiments can be similar to MO SMS call flows as described in FIG. 12. For example, prepaid SCP 907 may determine the account balance of the subscriber's prepaid account to be less than the minimum required, for establishing a PDP context between SGSN-V 122 and GGSN-V 124. Thereafter, at step 1310, GGSN-V 124 sends a PDP action return message to PLN service node 114. Once subscriber 106 has access to the GPRS services, a deduction mechanism can be followed based on the charges as per the subscriber's usage of the GPRS services. Thus, at step 1312, PLN service node 114 again sends a signaling message to prepaid SCP 907 for checking and deducting the credit amount from the subscriber's prepaid account on APN-V. Henceforth, at step 1314, prepaid SCP 907 returns an acknowledgement to PLN service node 114, which confirms successful deduction of credit amount from the subscriber's prepaid account based on his usage (e.g. data download). Finally, at step 1316, PLN service node 114 sends a PDP action return message to VMSC-V/VLR-V 120.

In accordance with another embodiment of the present invention, the MO GPRS procedure with CAMEL/IN support is similar to the MO GPRS procedure without CAMEL/IN support as explained above. However, the messages corresponding to IN protocol will be used to follow the call flow of the MO GPRS as in FIG. 13. Various message parameters like IMSI-H, PLN, B#, APN-H, and SGSN-V address in the MO GPRS case with CAMEL/IN support is similar to the MO GPRS case without CAMEL/IN support (as shown in FIG. 13). In the MO GPRS case with IN/CAMEL support, SGSN-V 122 sends the IDP GPRS message to PLN service node 114 on APN-H with IMSI-H, PLN, and the SGSN-V address. Thereafter, PLN service node 114 modifies the IDP SMS with IMSI-V, PLN, APN-V, and the SGSN-V address, and sends it to prepaid SCP 907. Prepaid SCP 907 sends an IN/CAP RRB ConnectGPRS or ContinueGPRS message to SGSN-V 122 via PLN service node 114, to answer the IDP-GPRS message. SGSN-V 122 relays an ERB-GPRS to prepaid SCP 907 via PLN service node 114. The ERB-GPRS message indicates an event that the IDP-GPRS message from the subscriber's PLN has been answered, and hence charging/deducting from the subscriber's prepaid account can be done. Thereafter, prepaid SCP 907 relays ReleaseGPRS, ContinueGPRS, and, ConnectGPRS to SGSN-V 122 via PLN service node 114, based on the credit amount in the subscriber's prepaid account. If subscriber 106 has sufficient balance in his prepaid account, the PDP context is established; otherwise, prepaid SCP 907 ignores the subscriber's request for the GPRS services. Thus, subscriber 106 can send SMS, originate calls, establish GPRS connection to access GPRS services, while being subscribed to the PLN Service in VPMN 104. However, in all the embodiments explained above, subscriber 106 is using HPMN 102 provided SIM card and its corresponding IMSI-H.

There maybe cases where the subscribers may like to use the allotted PLN for a longer duration. For example, Telefonic Panama subscriber may be a national outbound roamer and may frequently visit Cable Wireless Panama network coverage, thus, he may like to subscribe to the PLN service, in order to use the PLN provided by Cable Wireless Panama for a longer time. However, in some cases, the subscribers may choose to hold the allotted PLN for a relatively lesser time duration (such as one month). In such a case, once the period of one month is complete, the allocated PLN is sent back to the pool of pre-defined local numbers, maintained at PLN Service Node 114. In another embodiment of the present invention, if the subscribers do not use the allocated PLN for a configurable period, PLN service node 114 sends the PLN back to the pool of pre-defined local numbers for a grace period. Is it only after the completion of this grace period that the PLN is reused and allocated to a different subscriber subscribing to the PLN service in VPMN 104. The network operator (i.e. VPMN 104) providing the PLN service manages and controls the duration of the configurable period, after which the PLN is sent back to the pool of pre-defined local numbers. Additionally, these network operators can determine the Call Detail Record (CDR) of these subscribers from the VMSC/SGSN based on the MCC and MNC code in the subscriber's home network MSISDN. Alternatively, the network operators can determine the CDR of these subscribers from the VMSC/SGSN based on the PLN range.

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

A computer usable medium provided herein includes a computer usable program code, which when executed, facilitates mobile communication of a subscriber associated with a home network roaming in a visited network. The computer program product further includes a computer usable program code for receiving at a service node, a registration message from the subscriber to register with the visited network that has a No-Roaming Agreement (NRA) with the home network. The computer program product further includes a computer usable program code for sending by the service node, an update message to a switching unit to update a trigger profile information at the switching unit so as to enable redirection of call control associated with the subscriber to the service node. The computer program product further includes a computer usable program code for facilitating completion of the subscriber's registration process in the visited network by the service node. The computer program product further includes a computer usable program code for authenticating the subscriber by the service node with the home network using one or more parameters of the subscriber's profile information.

A visited network operator uses one or more variations of the present invention to allow subscriber to register with itself even when the visited network has NRA with these subscriber's home network. The present invention provides subscribers, associated with its network, with a PLN service when they are not in the coverage of home network and are in VPMN networks. Once these subscribers are registered at the VPMN network a welcome message offering the PLN service can be sent to these subscribers' handsets. Once these subscribers accept the offered PLN service, they can indicate one or more desired services like call forwarding or MCA that they want to activate or de-activate. The present system caters to both post-paid and pre-paid subscribers. Moreover, the present system provides a prepaid solution to these subscribers and they can use either a local scratch card or a credit card in order to top up their respective prepaid accounts in the VPMN networks. The PLN Service offered to these subscribers provide them with a PLN that allows them to perform various mobile activities in the VPMN networks at local rates. The present system allows subscribers to perform various call and non-call related activities in the VPMN networks, all at local rates as charged by these VPMNs. It also allows the subscribers to receive calls and SMS on their home network MSISDNs in addition to their respective PLNs. Further, the present system facilitates the subscribers to subscribe to various other services such as Value Added Services (VAS), even when they are in VPMN networks. Some of the VAS offered by the VPMN networks allow subscribers in the VPMN networks to forward calls on their home network number (i.e. MSISDN of the home network) to their PLN.

The system also provides subscribers with a relatively cost effective option to subscribe to Missed Call Alert (MCA) service that allow these subscribers to receive a MCA on to their PLN when a call on their home network MSISDN is received. This allows the subscribers not to miss any important calls on their home network MSISDNs (even while being in visited network) as the MCA service sends an SMS to the subscriber's handset that displays the calling party number (originating the call) and the time of call. Subscribers can thus call back the calling party number using his PLN while being charged at local rates instead of roaming rates that would otherwise have been charged had the subscriber picked the call on his home network's number. The MCA services also can send a MCA (the SMS) on the calling party's handset in case it is a mobile number so that the calling party can call back on the subscriber's PLN. The subscribers who are associated with network operators that operate both CDMA and GSM networks are also able to subscribe to the services of the present invention.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

Other Variations

Provided above for the edification of those of ordinary skill in the art, and not as a limitation on the scope of the invention, are detailed illustrations of a scheme for facilitating mobile communication of a subscriber associated with a home network roaming in a visited network. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third Generation of mobile |
| 3GPP | Third Generation Partnership Project |
| ACM | ISUP Address Completion Message |
| AIN | Advanced Intelligent Network |
| ANM | ISUP Answer Message |
| ANSI-41 | American National Standards Institute #41 |
| APN | Access Point Name |
| APN-H | HPMN APN |
| APN-V | VPMN APN |
| ATI | Any Time Interrogation |
| BCSM | Basic Call State Model |
| BSC | Base Station Controller |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CgPA | Calling Party Address |
| CDR | Call Detail Record |
| CLI | Calling Line Identification |
| CSD | Circuit Switched Data |
| CSI | Camel Subscription Information |
| DNS | Domain Name Server |
| DPC | Destination Point Code |
| DSD | Delete Subscriber Data |
| ERB | CAP Event Report Basic call state model |
| FPMN | Friendly Public Mobile Network of VPMN |
| FPMN′ | Friendly Public Mobile Network of HPMN |
| FTN | Forward-To Number |
| GGSN | Gateway GPRS Support Node |
| GGSN-V | GGSN in VPMN |
| GLR | Gateway Location Register |
| GMLC | Gateway Mobile Location Centre |
| GMSC | Gateway MSC |
| GMSC-F | GMSC in FPMN |
| GMSC-H | GMSC in HPMN |
| GMSC-V | GMSC in VPMN |
| GPRS | General Packet Radio System |
| GPRS-CSI | GPRS Camel Subscription Information |
| GSM | Global System for Mobile |
| gsmSSF | GSM Service Switching Function |
| gsmSCF | GSM Service Control Function |
| gsmCCF | GSM Call Control Function |
| GT | Global Title |
| HLR | Home Location Register |
| HLR-F | Forward-to number HLR |
| HLR-H | HPMN HLR |
| HLR-V | VPMN HLR |
| HPMN | Home Public Mobile Network |
| GTT | Global Title Translation |
| IAM | Initial Address Message |
| IDP | Initial DP IN/CAP message |
| IMSI | International Mobile Subscriber Identity |
| IMSI-H | HPMN IMSI |
| IMSI-R | FPMN′IMSI |
| IMSI-V | VPMN IMSI |
| IN | Intelligent Network |
| INAP | Intelligent Network Application Part |
| INE | Interrogating Network Entity |
| IP | Internet Protocol |
| ISC | International Service Carrier |
| ISD | MAP Insert Subscriber Data |
| ISG | International Signal Gateway |
| ISTP | International STP |
| ISTP-F | ISTP connected to FPMN STP |
| ISTP-H | ISTP connected to HPMN STP |
| ISUP | ISDN User Part |
| ITR | Inbound Traffic Redirection |
| IVR | Interactive Voice Response |
| LCS | LoCation Service |
| LU | Location Update |
| LUP | MAP Location Update |
| MAP | Mobile Application Part |
| MCA | Missed Call Alert |
| MCC | Mobile Country Code |
| MCC | Mobile Country Code |
| ME | Mobile Equipment |
| MGT | Mobile Global Title |
| MMI | Man Machine Interface |
| MMS | Multimedia Message Service |
| MMSC | Multimedia Message Service Center |
| MMSC-F | Forward-to number MMSC |
| MMSC-H | HPMN MMSC |
| MMSC-V | VPMN MMSC |
| MNC | Mobile Network Code |
| MO | Mobile Originated |
| MSC | Mobile Switching Center |
| MSISDN | Mobile Station International Subscriber Directory Number |
| MSISDN-F | Forward-to number MSISDN |
| MSISDN-H | HPMN MSISDN |
| MSRN | Mobile Station Roaming Number |
| MSRN-F | Forward-to number MSRN |
| MSRN-H | HPMN MSRN |
| MT | Mobile Terminated |
| MTP | Message Transfer Part |
| NDC | National Dialing Code |
| NRA | No Roaming Agreement |
| NP | Numbering Plan |
| NPI | Numbering Plan Indicator |
| OCN | Originally Called Number |
| O-CSI | Originating CAMEL Subscription Information |
| ODB | Operator Determined Barring |
| OTA | Over The Air |
| PDP | Packet Data Protocol |
| PPG | Push Proxy Gateway |
| PRN | MAP Provide Roaming Number |
| PSL | Provide Subscriber Location |
| PSI | MAP Provide Subscriber Information |
| PLN | Prepaid Local Number |
| REL | ISUP Release Message |
| RI | Routing Indicator |
| RNA | Roaming Not Allowed |
| RR | Roaming Replicator |
| RR-F | Roaming Replicator in FPMN |
| RR-F′ | Roaming Replicator in FPMN′ |
| RRB | CAP Request Report Basic call state model |
| RSD | ReStore Data |
| SAI | Send Authentication Information |
| SCCP | Signal Connection Control part |
| SCP | Signaling Control Point |
| SCP-H | HPMN SCP |
| SG | Signaling Gateway |
| SGSN | Serving GPRS Support Node |
| SGSN-H | HPMN SGSN |
| SGSN-F | Forward-to number SGSN |
| SGSN-V | VPMN SGSN |
| SIM | Subscriber Identity Module |
| SIP | Session Initiation Protocol |
| SME | Short Message Entity |
| SM-RP-UI | Short Message Relay Protocol User Information |
| SMS | Short Message Service |
| SMS-CSI | SMS Camel Subscription Information |
| SMSC | Short Message Service Center |
| SMSC-O | Originating SMSC |
| SMSC-F | Forward-to number SMSC |
| SMSC-H | HPMN SMSC |
| SMSC-V | VPMN SMSC |
| SPC | Signal Point Code |
| SRI | MAP Send Routing Information |
| SRI-LCS | MAP Send Routing Information For LoCation Service |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TCAP | Transaction Capabilities Application Part |
| T-CSI | Terminating CAMEL Service Information |
| TP | SMS Transport Protocol |
| TR | Traffic Redirection |
| TT | Translation Type |
| UD | User Data |
| UDH | User Data Header |
| UDHI | User Data Header Indicator |
| UMTS | Universal Mobile Telecommunications System |
| USSD | Unstructured Supplementary Service Data |
| VAS | Value Added Service |
| VLR | Visited Location Register |
| VLR-F | Forward-to Number VLR |
| VLR-H | HPMN VLR |
| VLR-V | VPMN VLR |
| VMSC | Visited Mobile Switching Center |
| VMSC-F | Forward-to Number VMSC |
| VMSC-H | HPMN VMSC |
| VMSC-V | VPMN VMSC |
| VPMN | Visited Public Mobile Network |
| WAP | Wireless Access Protocol |
| WIN | Wireless Intelligent Network |

### TECHNICAL REFERENCES (EACH OF WHICH IS INCORPORATED BY THIS REFERENCE HEREIN)

Providing multiple MSISDN numbers in a mobile device with a single IMSI, U.S. patent application Ser. No. 10/782,681;
Dynamic originating CAMEL approach for Implementing Call Control Services for Inbound Roamers, U.S. Provisional Patent Application Ser. No. 60/679,444;
Signal Packet Relay System PCT/US 2004/004333;
Fixed-line Missed Call Alert, U.S. Provisional Patent Application Ser. No. 60/631,337;
BA 30 New Binding PRD BA.30—Steering of Roaming Operational Guidelines;
GSM 902 on MAP specification
GSM 340 on SMS
GSM 378 on CAMEL
GSM 978 on CAMEL Application Protocol
GSM 379 on CAMEL Support of Optimal Routing (SOR)
GSM 318 on CAMEL Basic Call Handling
ITU-T Recommendation Q.1214 (1995), Distributed functional plane for intelligent network CS-1;
ITU-T Recommendation Q.1218 (1995), Interface Recommendation for intelligent network CS-1;
ITU-T Recommendation Q.762 (1999), Signaling system No. 7—ISDN user part general functions of messages and signals;
ITU-T Recommendation Q.763 (1999), Signaling system No. 7—ISDN user part formats and codes;
ITU-T Recommendation Q.764 (1999), Signaling system No. 7—ISDN user part signaling procedures;
ITU-T Recommendation Q.766 (1993), Performance objectives in the integrated services digital network application;
ITU-T Recommendation Q.765 (1998), Signaling system No. 7—Application transport mechanism;
ITU-T Recommendation Q.769.1 (1999), Signaling system No. 7—ISDN user part enhancements for the support of Number Portability.

I claim:

1. A method for facilitating mobile communication of a subscriber associated with a home network roaming in a visited network, the visited network having a service node and a switching unit, the method comprising:
receiving, at the service node, a registration message from the subscriber for registering with the visited network, wherein the visited network has a No-Roaming Agreement (NRA) with the home network;
transmitting an update message for updating trigger profile information to the switching unit, the trigger profile information enabling redirection of call control associated with the subscriber to the service node;
facilitating completion of the subscriber's registering with the visited network; and
authenticating the subscriber, via the service node, with the home network using at least one parameter associated with the subscriber.

2. The method of claim 1, wherein the trigger profile information is transmitted with one selected from a group consisting of a Prepaid Local Number (PLN) and a special PLN.

3. The method of claim 2, wherein the subscriber has an International Mobile Subscriber Identity (IMSI) for the home network and an IMSI for the visited network, and wherein each of the PLN and the special PLN is selected from a plurality of pre-defined local numbers of the visited network, each pre-defined local number having a corresponding IMSI.

4. The method of claim 3, wherein the trigger profile information is transmitted with the PLN and wherein the visited network has an associated prepaid service control node, the method further comprising:
updating the prepaid service control node with at least one selected from a group consisting of the PLN and the subscriber's IMSI for the visited network, for use in maintaining billing records for the subscriber's mobile communication in the visited network.

5. The method of claim 1, wherein the trigger profile information is transmitted using one selected from a group consisting of an ISDN User Part (ISUP) based trigger, an Intelligent Network (IN) based trigger, an Advanced Intelligent Network (AIN) based trigger, a Wireless Intelligent Network (WIN) based trigger, and a Customized Applications for Mobile network Enhanced Logic (CAMEL) based trigger.

6. The method of claim 4, wherein the trigger information is transmitted with the PLN, wherein the PLN is assigned to the subscriber, the subscriber having a Mobile Station International Subscriber Directory Number (MSISDN) associated with the home network, and wherein the home network has an associated gateway switching center, the method further comprising:
forwarding a call received on the subscriber's MSISDN to the subscriber's assigned PLN via the gateway switching center.

7. The method of claim 1, wherein the visited network has an associated gateway switching center configured to redirect signaling messages corresponding to the subscriber and destined for the home network to the service node.

8. The method of claim 1, wherein the subscriber has a Mobile Station International Subscriber Directory Number (MSISDN) associated with the home network, and wherein the at least one parameter associated with the subscriber includes a confirmation request message for verifying the subscriber's MSISDN.

9. The method of claim 1, wherein the visited network has a roaming agreement with a sponsoring network, and wherein the subscriber is authenticated by redirecting an authentication request message to the home network via the sponsoring network.

10. The method of claim 1, wherein the service node has an associated data repository, the method further comprising:
storing the at least one parameter in the data repository subsequent to authentication of the subscriber.

11. The method of claim 1, wherein the home network and the visited network each has a SS7 inter-working relationship, and wherein the subscriber is authenticated using the SS7 inter-working relationship.

12. The method of claim 1, wherein the subscriber is authenticated via a non-SS7 inter-working operator, the method further comprising:
transmitting an instruction to the subscriber, via the service node, to retrieve a Personal Identification Number (PIN) from a message transmitted to the subscriber.

13. The method of claim 12, wherein the home network has a partner network in proximity to the visited network, the method further comprising:
registering the subscriber with one selected from a group consisting of the home network and the partner network, so as to allow retrieval of the PIN.

14. A system for facilitating mobile communication of a subscriber associated with a home network when roaming in a visited network, the system comprising:
a service node for receiving a registration message from the subscriber for registering with the visited network, wherein the visited network has a No-Roaming Agreement (NRA) with the home network; and
a switching unit associated with the visited network for receiving an update message from the service node for updating trigger profile information, the updated trigger profile information enabling redirection of call control associated with the subscriber to the service node;
wherein the service node facilitates completion of the subscriber's registering with the visited network; and
wherein the service node authenticates the subscriber with the home network using at least one parameter associated with the subscriber.

15. The system of claim 14, wherein the trigger profile information is transmitted with one selected from a group consisting of a prepaid local number (PLN) and a special PLN.

16. The system of claim 15, wherein the subscriber has an International Mobile Subscriber Identity (IMSI) for the home network and an IMSI for the visited network, and wherein each of the PLN and the special PLN is selected from a plurality of pre-defined local numbers of the visited network, each pre-defined local number having a corresponding IMSI.

17. The system of claim 16, wherein the trigger profile information is transmitted with the PLN, the system further comprising:
a prepaid service control node associated with the visited network;
wherein the service node updates the prepaid service control node with at least one selected from a group consisting of the PLN and the subscriber's IMSI for the visited network, for use in maintaining billing records for the subscriber's mobile communication in the visited network.

18. The system of claim 14, wherein the trigger profile information is transmitted using one selected from a group consisting of an ISDN User Part (ISUP) based trigger, an Intelligent Network (IN) based trigger, an Advanced Intelligent Network (AIN) based trigger, a Wireless Intelligent Network (WIN) based trigger, and a Customized Applications for Mobile network Enhanced Logic (CAMEL) based trigger.

19. The system of claim 15, wherein the trigger profile information is transmitted with the PLN wherein the PLN is assigned to the subscriber, the subscriber having a Mobile Station International Subscriber Directory Number (MSISDN) associated with the home network, the system further comprising:
a gateway switching center associated with the home network for forwarding a call received on the subscriber's MSISDN to the subscriber's assigned PLN.

20. The system of claim 14, further comprising:
a gateway switching center associated with the visited network configured to redirect signaling messages corresponding to the subscriber and destined for the home network to the service node.

21. The system of claim 14, wherein a gateway switching center associated with the visited network is configured to route all signaling messages corresponding to the subscriber's PLN to the service node.

22. The system of claim 14, wherein the subscriber has a Mobile Station International Subscriber Directory Number (MSISDN) associated with the home network, and wherein the at least one parameter associated with the subscriber includes a confirmation request message for verifying the subscriber's MSISDN.

23. The system of claim 14, wherein the visited network has a roaming agreement with a sponsoring network, and wherein the subscriber is authenticated by redirecting an authentication request message to the home network via the sponsoring network.

24. The system of claim 14 further comprising:
a data repository associated with the service node for storing the at least one parameter in the data repository subsequent to authentication of the subscriber.

25. The system of claim 14, wherein the home network and the visited network each has a SS7 inter-working relationship, and wherein the subscriber is authenticated using the SS7 inter-working relationship.

26. The system of claim 14, wherein the subscriber is authenticated via a non-SS7 inter-working operator, and wherein the service node transmits an instruction to the subscriber to retrieve a Personal Identification Number (PIN) from a message transmitted to the subscriber.

27. The system of claim 26, wherein the home network has a partner network in proximity to the visited network, and wherein the subscriber registers with one selected from a group consisting of the home network and the partner network, so as to allow retrieval of the PIN.

28. A computer program product comprising a computer usable medium having stored thereon a computer usable program code for facilitating mobile communication of a subscriber associated with a home network roaming in a visited network, the visited network having a service node and a switching unit, the computer program product comprising:
computer usable program code means for receiving, at the service node, a registration message from the subscriber for registering with the visited network, wherein the visited network has a No-Roaming Agreement (NRA) with the home network; and
computer usable program code means for transmitting to the switching unit, via the service node, an update message for updating trigger profile information, the updated trigger profile information enabling redirection of call control associated with the subscriber to the service node;
wherein the service node facilitates completion of the subscriber's registering with the visited network; and
wherein the service node authenticates the subscriber with the home network using at least one parameter associated with the subscriber.
